(19) United States
(12) Patent Application Publication
(10) Pub. No.: US 2012/0211702 A1
(43) Pub. Date: Aug. 23, 2012

(54) Electrically Conducting Polymer And Copolymer Compositions, Methods For Making Same And Applications Therefor

(75) Inventors: Arthur J. Epstein, Bexley, OH (US); Yong Min, Columbus, OH (US); Jen-Chieh Wu, Mountain View, CA (US)

(73) Assignee: THE OHIO STATE UNIVERSITY, Columbus, OH (US)

(21) Appl. No.: 13/388,167

(22) PCT Filed: Aug. 2, 2010
(86) PCT No.: PCT/US10/44166

§ 371 Date: May 11, 2012

Related U.S. Application Data
(60) Provisional application No. 61/230,556, filed on Jul. 31, 2009.

(51) Int. Cl. H01B 1/12; C08G 69/26; C08G 73/02; C08G 75/00; C08G 79/08

(52) U.S. Cl. 252/500; 528/391; 528/7; 528/271; 528/332

(57) ABSTRACT

The present invention relates generally to substituted polyaniline polymer/copolymer compositions, suitable slats thereof and uses therefore. In one embodiment, the present invention relates to conductive substituted polyaniline polymer/copolymer compositions, suitable slats thereof and uses therefore. In still another embodiment, the present invention relates to self-protonated substituted polyaniline polymer/copolymer compositions, suitable slats thereof and uses therefore. In yet another embodiment, the present invention relates to self-protonated sulfonic acid- or boric acid-substituted polyaniline polymer/copolymer compositions, suitable slats thereof and uses therefore. In still another embodiment, the one or more various polyaniline polymer/copolymer compositions of the present invention are both biodegradable and conducting polymer compositions.

### RELATED APPLICATION DATA

This patent application claims priority to U.S. Provisional Patent Application No. 61/230,556, filed on Jul. 31, 2009, entitled “Electrically Conduction Co-Polymer Compositions, Methods for Making Same and Applications Therefor,” the entirety of which is hereby incorporated by reference herein.

### FIELD OF THE INVENTION

The present invention relates generally to substituted polyaniline polymer/copolymer compositions, suitable slats thereof and uses therefore. In one embodiment, the present invention relates to conductive substituted polyaniline polymer/copolymer compositions, suitable slats thereof and uses therefore. In still another embodiment, the present invention relates to self-protonated substituted polyaniline polymer/copolymer compositions, suitable slats thereof and uses therefore. In yet another embodiment, the present invention relates to self-protonated sulfonic acid- or boric acid-substituted polyaniline polymer/copolymer compositions, suitable slats thereof and uses therefore. In still another embodiment, the one or more various polyaniline polymer/copolymer compositions of the present invention are both biodegradable and conducting polymer compositions.

### BACKGROUND OF THE INVENTION

Conductive polymers are organic polymers that conduct electricity. Such compounds may be true metallic conductors or semiconductors. It is generally accepted that metals conduct electricity well and that organic compounds are insulating, but this class of materials combines the properties of both. The biggest advantage of conductive polymers is their processability. Conductive polymers are also plastics (which are organic polymers) and therefore can combine the mechanical properties (flexibility, toughness, malleability, elasticity, etc.) of plastics with high electrical conductivities. Their properties can be fine-tuned using the exquisite methods of organic synthesis. (See Herbert Naarmann, Polymers, Electrically Conducting, Ullmann's Encyclopedia of Industrial Chemistry 2002, Wiley-VCH, Weinheim. Doi: 10.1002/14356007.a21 429).

Classes of Materials: Well-studied classes of organic conductive polymers include poly(acetylene)s, poly(pyrrole)s, poly(thiophene)s, polyanilines, polythiophenes, poly(p-phenylene sulfide), and poly(para-phenylene vinylene)s (PPV). PPV and its soluble derivatives have emerged as the prototypical electroluminescent semiconducting polymers. Today, poly(3-alkylthiophenes) are the archetypical materials for solar cells and transistors. Other less well studied conductive polymers include polyindole, polypyrene, polycarbazole, polyazulene, polyazepine, poly(fluorene)s, and polynaphthalene as listed in the following.

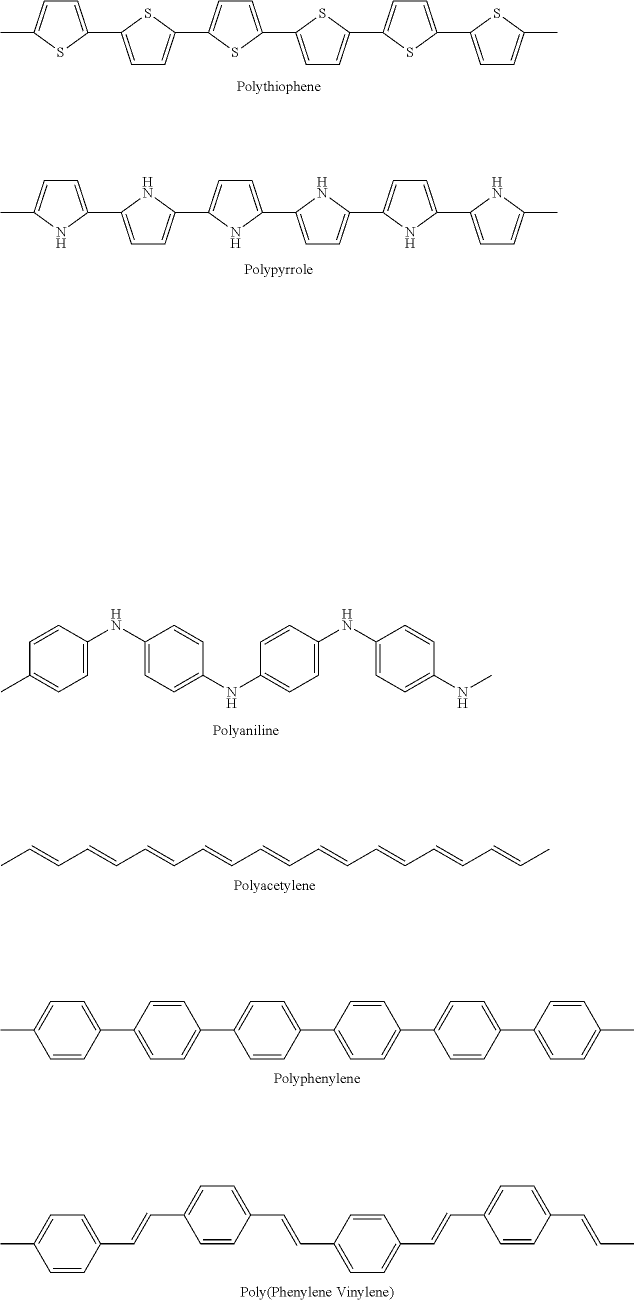

As can be seen from FIG. 1, the above polymers possess suitable conductivities only when doped. To date, such doped conductive polymers are either not suitable for use in biological applications, or do not maintain suitable conductivities at pH levels encountered in biological applications (e.g., a pH of about 7.4).

Self-Doped Conducting Polymers: When ionizable functional groups that form negatively charged sites are attached to the polymer chain to make the polymer conducting, it is referred to as “self-doping” or when the group is an acid, “self-acid-doping.” The distinctive properties of self-doped conducting polymers are their water solubility, electroactivity and conductivity over a wider pH range (in the case of polyaniline), and thermal stability. The ionizable groups on the backbone give the polymer certain polyelectrolyte properties, i.e., these groups dissociate into aqueous solvent. The solubility of self-doped conducting polymers in aqueous solutions can be attributed to the hydrophilic interactions between the covalently attached ionized group on the polymer backbone and polar molecules of water. In water, the steric and ionic repulsive interactions overcome the interchain interactions and allow for the rapid solvation of polymer backbone. (P24, Self-Doped Conducting Polymers, M. S. Freund and B. A. Deore, 2007, John Wiley & Sons, Ltd)

Several examples of self-doped conducting polymers are listed in the following: (1) Oxidation-reduction reactions of polythiophene derivatives showing self-doping during the oxidation reactions. (A. O. Patil et al., Synthetic Metals, 20, p. 151)

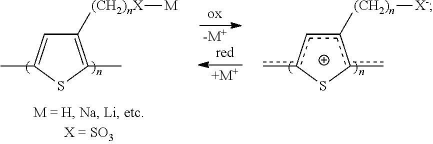

(2) chemical structure of self-doped poly(pyrrole-co(3-(pyrrol-lyl)propanesulfonate) (see N. S. Sundarsan et al., Chemical Communications, 1987, p. 621).

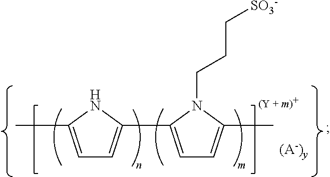

(3) chemical structures of (A) self-doped ring-sulfonated polyaniline and (B) de-doped (insulating) salt form of ring-sulfonated polyaniline. (see Journal of the American Chemical Society, 112, p. 2800).

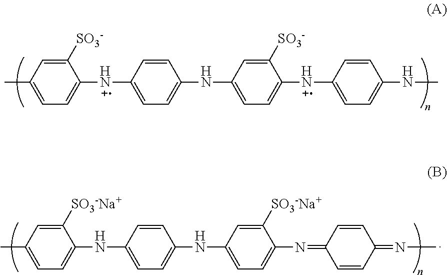

Polyaniline is a family of polymers that has been under intensive study recently because the electronic and optical properties of the polymers can be modified through variations of either the number of protons, the number of electrons, or both. The polyaniline polymer can occur in several general forms including the so-called reduced form (leucoemeraldine base), possessing the general formula:

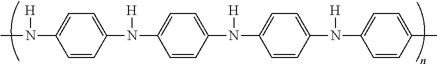

the partially oxidized so-called emeraldine base form, of the general formula:

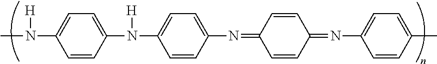

and the fully oxidized so-called pernigraniline form, of the general formula:

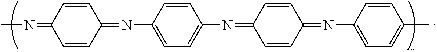

In practice, polyaniline generally exists as a mixture of the several forms with a general formula (I) of:

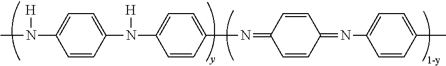

where 0≦y≦1, the polyaniline polymers are referred to as poly(paraphenyleneamineimines) in which the oxidation state of the polymer continuously increases with decreasing value of y. The fully reduced poly(paraphenyleneamine) is referred to as leucoemeraldine, having the repeating units indicated above corresponding to a value of y=1. The fully oxidized poly(paraphenyleneimine) is referred to as pernigraniline, of repeat unit shown above corresponds to a value of y=0. The partly oxidized poly(paraphenyleneamineimine) with y in the range of greater than or equal to 0.35 and less than or equal to 0.65 is termed emeraldine, though the name emeraldine is often focused on y equal to or approximately 0.5 composition. Thus, the terms “leucoemeraldine,” “emeraldine” and “pernigraniline” refer to different oxidation states of polyaniline. Each oxidation state can exist in the form of its base or in its protonated form (salt) by treatment of the base with an acid.

The use of the terms “protonated” and “partially protonated” herein includes, but is not limited to, the addition of hydrogen ions to the polymer by, for example, a protonic acid, such as mineral and/or organic acids. The use of the terms “protonated” and “partially protonated” herein also includes pseudoprotonation, wherein there is introduced into the polymer a cation such as, but not limited to, a metal ion, M. For example, “50 percent” protonation of emeraldine leads formally to a composition of the formula:

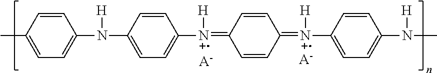

which may be rewritten as:

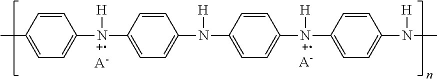

Formally, the degree of protonation may vary from a ratio of [H⁺]/[—N═]=0 to a ratio of [H⁺]/[—N═]=1. Protonation or partial protonation at the amine (—NH—) sites may also occur.

The electrical and optical properties of the polyaniline polymers vary with the different oxidation states and the different forms. For example, the leucoemeraldine base (LEB), emeraldine base (EB) and pernigraniline base forms of the polymer are electrically insulating while the emeraldine salt (protonated) form of the polymer is conductive. Protonation of emeraldine base by aqueous HCl (1M HCl) to produce the corresponding salt brings about an increase in electrical conductivity of approximately 10¹²; deprotonation occurs reversibly in aqueous base or upon exposure to vapor of, for example, ammonia. The emeraldine salt form can also be achieved by electrochemical oxidation of the leucoemeraldine base polymer or electrochemical reduction of the pernigraniline base polymer in the presence of an electrolyte of the appropriate pH. The rate of the electrochemical reversibility is very rapid; solid polyaniline can be switched between conducting, protonated and non-conducting states at a rate of approximately 10⁵ Hz for electrolytes in solution and even faster with solid electrolytes. (E. Paul et al., J. Phys. Chem. 1985, 89, pp. 1441 to 1447). The rate of electrochemical reversibility is also controlled by the thickness of the film, thin films exhibiting a faster rate than thick films. Polyaniline can then be switched from insulating to conducting form as a function of protonation level (controlled by ion insertion) and oxidation state (controlled by electrochemical potential). Thus, in contrast to, other polymeric materials for example, polypyrrole, polyaniline can be turned “on” by either a negative or a positive shift of the electrochemical potential, because polyaniline films are essentially insulating at sufficiently negative (approximately 0.00 V vs. SCE) or positive (+0.7 V vs. SCE) electrochemical potentials. Polyaniline can also then be turned “off” by an opposite shift of the electrochemical potential.

The conductivity of polyaniline is known to span 12 orders of magnitude and to be sensitive to pH and other chemical parameters. It is well-known that the resistance of films of both the emeraldine base and 50 percent protonated emeraldine hydrochloride polymer decrease by a factor of approximately 3 to 4 when exposed to water vapor. The resistance increases only very slowly on removing the water vapor under dynamic vacuum. The polyaniline polymer exhibits conductivities of approximately 1 to 20 Siemens per centimeter (S/cm) when approximately half of its nitrogen atoms are protonated. Electrically conductive polyaniline salts, such as fully protonated emeraldine salt [(—C₆H₄—NH—C₆H₄—NH⁺)—Cl⁻]ₓ, have high conductivity (10⁻⁴ to 10⁺² S/cm) and high dielectric constants (20 to 200) and have a dielectric loss tangent of from below 10⁻³ to approximately 10¹. Dielectric loss values are obtained in the prior art by, for example, carbon filled polymers, but these losses are not as large or as readily controlled as those observed for polyaniline.

Synthetic biodegradable polymers are the organic-based polymers which can be degraded or catabolized in the natural environment with or without the help of microorganisms. The degraded products of the synthetic biodegradable polymers can enter into the biological metabolic pathways; therefore, biodegradable polymers are suitable for biomedical and environmental applications.

The typical synthetic biodegradable polymers are polyesters which contain ester bonds in their repeating units. The ester bonds can be hydrolyzed to provide products with carboxylic acid and hydroxyl ends; those shorter degraded polymers could undergo further hydrolysis until all units. The synthetic biodegradable polymers can be degraded by this way. Polylactic acid, for example, can be degraded to provide lactic acid monomers which are easily metabolized (see Prog. Polym. Sci., 27 (2002), pp. 87 to 133).

Many opportunities exist for the application of synthetic biodegradable polymers in the biomedical area for many reasons. Degradation of the polymer implant means surgical intervention is not required for removal, eliminating the need for a second surgery. In the role of tissue engineering biodegradable polymers can be designed such to approximate soft tissues, providing a polymer scaffold that can withstand resistance, provide a suitable surface for cell attachment and growth and degrade at a rate that allows the load to be transferred to the new tissue. In the field of controlled drug delivery biodegradable polymers offer tremendous potential as a basis for drug delivery, either as a drug delivery system alone or in conjunction to functioning as a medical device.

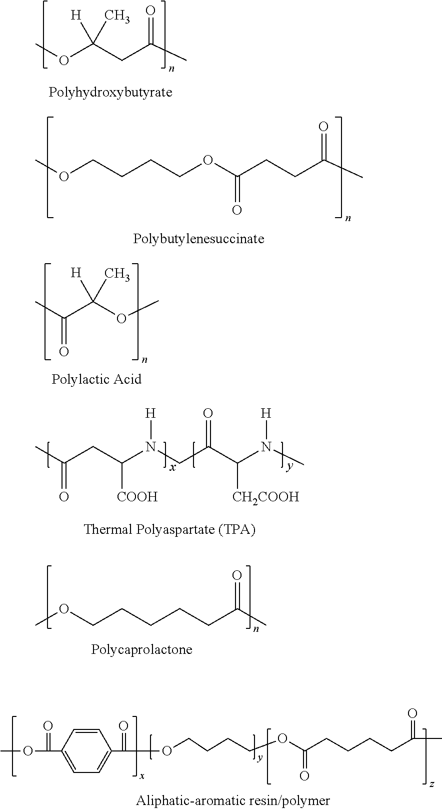

The above structures detail various synthesized biodegradable polymers.

Given this, there is a need in the art for various electrically conductive polymer and/or copolymer compositions, methods of forming such compositions and to use thereof.

### SUMMARY OF THE INVENTION

The present invention relates generally to conducting copolymer composite-polymer compositions, suitable slats thereof and uses therefore. In one embodiment, the present invention relates to conductive substituted polyaniline polymer/copolymer compositions, suitable slats thereof and uses therefore. In still another embodiment, the present invention relates to self-protonated substituted polyaniline polymer/copolymer compositions, suitable slats thereof and uses therefore. In yet another embodiment, the present invention relates to self-protonated sulfonic acid- or boric acid-substituted polyaniline polymer/copolymer compositions, suitable slats thereof and uses therefore. In still another embodiment, the one or more various polyaniline polymer/copolymer compositions of the present invention are both biodegradable and conducting polymer compositions.

In one embodiment, the present invention relates to any of the polymer and/or copolymer compositions (e.g., biodegradable and conducting copolymer compositions) disclosed and/or discussed herein, including any attachments to this patent application.

In another embodiment, the present invention relates to any method disclosed and/or discussed herein, including any method disclosed and/or discussed in any attachment to this patent application, relating to a manner in which to produce and/or manufacture any of the polymer and/or copolymer compositions (e.g., biodegradable and conducting copolymer compositions) disclosed and/or discussed herein.

In still another embodiment, the present invention relates to a self-doped polymer, or copolymer, composition according to Formulas (I), (II) and/or (III):

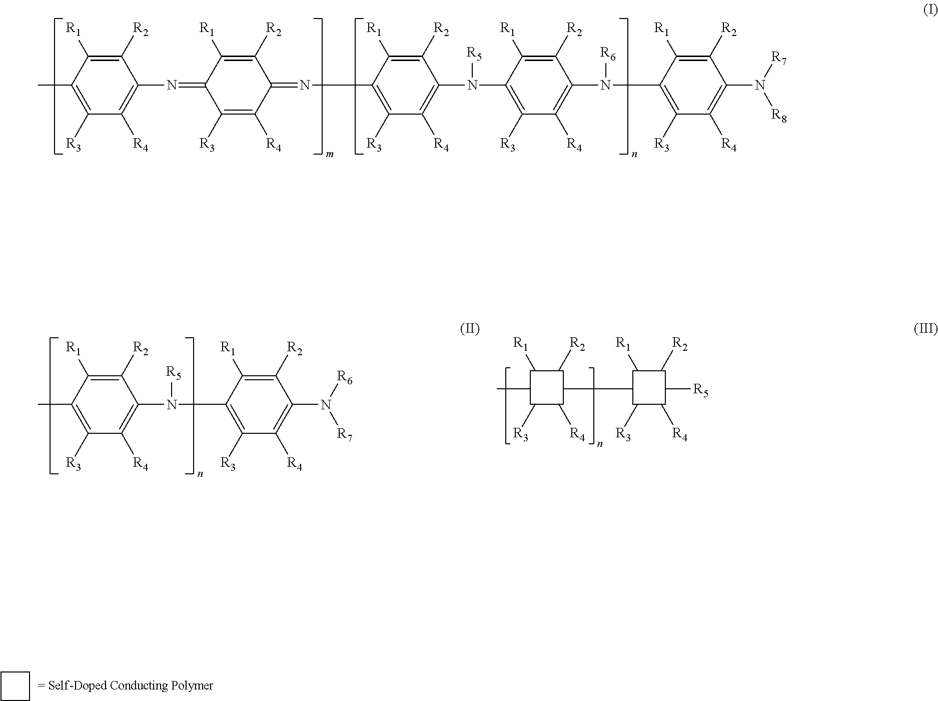

wherein m and n are independently integers selected from 2 to about 10,000, R₁, R₂, R₃, R₄, R₅, R₆, R₇ and R₅ are independently selected from H, —SO₃M, —R₉SO₃M, —OCH₃, —CH₃, —C₂H₅, —F, —Cl, —Br, —I, —N(R₉)₂, —NHCOR₉, —OH, —O⁻, —SR₉, —OR₉, —OCOR₉, —NO₂, —COOH, —COOR₉, —COR₉, —CHO, —CN, —SO₃H, —B(OH)₂, —SO₃⁻ or B(R₁₀)₂, wherein R₉ is a C₁ to C₈ alkyl, aryl or aralkyl group, R₁₀ is a H, a C₁ to C₈ alkyl, aryl or aralkyl group, C₁ to C₈ straight or branched alkyl, a C₁ to C₈ alkyl, aryl or aralkyl group that contains one or more heteroatoms selected from N, S or O, and wherein M is a H or an unsubstituted or substituted ammonia of the formula NA₁A₂A₃ and A₁, A₂ and A₃ are independently selected from H and C₁ to C₈ straight or branched alkyl.

### BRIEF DESCRIPTION OF THE DRAWINGS

FIG. 1 is a graph detailing the conductivities of various doped polymer compositions as compared to some common conductive materials;

FIG. 2 is a graph detailing the conductivities of various polymer compounds at various pHs;

FIG. 3 is an illustration of a synthesis route according to one embodiment of the present invention for producing a low molecular weight SPAN in according with the present invention;

FIG. 4 is an illustration of a synthesis route according to one embodiment of the present invention for producing low molecular weight polyaniline and SPAN utilizing direct solvent subtraction;

FIG. 5 is an illustration of a synthesis route according to one embodiment of the present invention for the production of a PANI EB-PCL copolymer and the preparation of a PSSA-doped copolymer;

FIG. 6 is an illustration of a synthesis route according to one embodiment of the present invention for the production of an oligoaniline compound;

FIG. 7 is an illustration of a synthesis route according to one embodiment of the present invention for the production of an oligoaniline-PCL copolymer compound;

FIG. 8 is an illustration of various synthesis routes in accordance with multiple embodiments of the present invention that are utilized to produce various doped PANI compounds in accordance with the present invention;

FIG. 9 is a chart and graph detailing the synthesis of various sulfonated polyaniline compounds having various amounts of doping by weight percent as well as various termination compounds in accordance with the present invention;

FIG. 10 is an illustration relating to one synthesis method for producing boronic SPAN (B-SPAN) according to the present invention;

FIG. 11 is an illustration of both a synthesis route in accordance with one embodiment of the present invention and a method by which to form tissue scaffolding from such compounds;

FIG. 12 is a table relating to various conductive copolymer compositions formed in accordance with the present invention, including some that are conductive polyester co-polymer compositions, where ES stands for emeraldine salt;

FIG. 13 is an illustration detailing an enzymatic synthesis route for conducting polymers—PCL copolymers;

FIG. 14 is a graph of various FTIR-traces of polyaniline-PCL copolymers in accordance with the present invention;

Figure is an NMR of polylactic acid (PLA) and related copolymer;

FIG. 16 is an NMR of polycaprolaton (PCL) and related copolymer;

FIG. 17 is a collection of DSC traces of various copolymers of the present invention and comparative compounds showing that the copolymers of the present invention have higher Tₘs than the pure PCL by DSC study;

FIG. 18 is an illustration of a reaction by which doping/de-doping can occur as well as absorbance data for the two different compounds illustrating the changes associated with the doping/de-doping process;

FIG. 19 is a bar graph detailing cell viability in various compositions;

FIG. 20 is a graph that details the amount weight loss in various biodegradable compositions over time;

FIG. 21 is a set of images showing live cells and dead cells;

FIG. 22 illustrates various cell numbers per square mm for SPAn-25, 30, and 50 and pure PCL as a control, and the cell survival rate for SAPN25, 40, 50 versus pure PCL;

FIG. 23 is a graph detailing viabilities of cell survival rate for tetramer-PCL, EB-PCL, SPAN-PCL versus pure PCL as a control;

FIG. 24 is an illustration of a suitable electronic circuit for electrospinning of a composition in accordance with the present invention;

FIG. 25 is an illustration of a scheme using a PDMS stamp fabrication method to form a scaffold structure in accordance with one embodiment of the present invention;

FIG. 26 illustrates a scheme of using a scaffold fabrication method to form a scaffold structure in accordance with one embodiment of the present invention;

FIG. 27 is an illustration detailing one method in accordance with the present invention for producing three-dimensional electrical conductive scaffolds;

FIG. 28 is an illustration detailing one suitable method for producing conducting hard scaffolds from one or more compositions of the present invention using soft lithography techniques;

FIG. 29 is an illustration detailing one method in accordance with the present invention for the fabrication of electrodes;

FIG. 30 is an illustration detailing one method in accordance with the present invention for the fabrication of electrodes;

FIG. 31 is an illustration containing a graph of conductivity versus temperature change for various examples in accordance with the present invention;

FIG. 32 is an illustration of a method for fabricating conducting coaxial-fiber scaffolds via an electrospinning technique;

FIG. 33 is an illustration of a method for fabricating conducting scaffolds via a multi-steps in-situ polymerization process;

FIG. 34 are graphs detailing HOS cell response to electrical stimulation;

FIG. 35 is an illustration containing details relating to BMSC and MC3T3 cells response to electrical stimulation; and

FIGS. 36 and 37 are illustration on various scaffold production methods that are within the scope of the present invention and can be utilized in conjunction with the compounds disclosed herein.

### DETAILED DESCRIPTION OF THE INVENTION

The present invention relates generally to substituted polyaniline polymer/copolymer compositions, suitable slats thereof and uses therefore. In one embodiment, the present invention relates to conductive substituted polyaniline polymer/copolymer compositions, suitable slats thereof and uses therefore. In still another embodiment, the present invention relates to self-protonated substituted polyaniline polymer/copolymer compositions, suitable slats thereof and uses therefore. In yet another embodiment, the present invention relates to self-protonated sulfonic acid- or boric acid-substituted polyaniline polymer/copolymer compositions, suitable slats thereof and uses therefore. In still another embodiment, the one or more various polyaniline polymer/copolymer compositions of the present invention are both biodegradable and conducting polymer compositions.

In one embodiment, the substituted polyaniline portion of the polymer/copolymer compositions of the present invention utilize at least one polymer composition defined by the structures below:

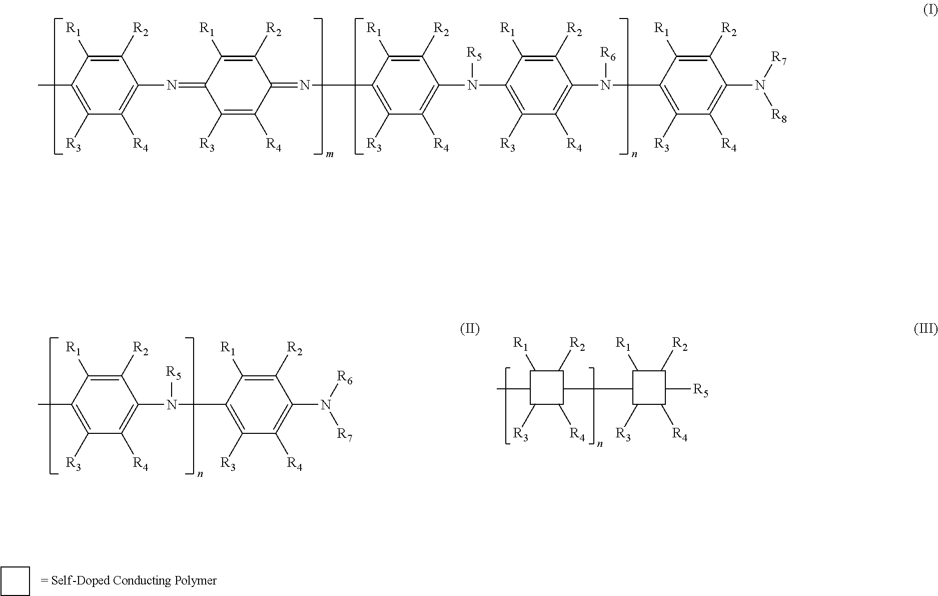

wherein m and n are independently integers selected from 2 to about 10,000, R₁, R₂, R₃, R₄, R₅, R₆, R₇ and R₅ are independently selected from H, —SO₃M, —R₉SO₃M, —OCH₃, —CH₃, —C₂H₅, —F, —Cl, —Br, —I, —N(R₉)₂, —NHCOR₉, —OH, —O⁻, —SR₉, —OR₉, —OCOR₉, —NO₂, —COOH, —COOR₉, —COR₉, —CHO, —CN, —SO₃H, —B(OH)₂, —SO₃⁻ and B(R₁₀)₂ wherein R₉ is a C₁ to C₈ alkyl, aryl or aralkyl group, R₁₀ is a H, a C₁ to C₈ alkyl, aryl or aralkyl group, C₁ to C₈ straight or branched alkyl, a C₁ to C₈ alkyl, aryl or aralkyl group that contains one or more heteroatoms selected from N, S or O, and wherein M is a H or an unsubstituted or substituted ammonia of the formula NA₁A₂A₃ and A₁, A₂ and A₃ are independently selected from H and C₁ to C₈ straight or branched alkyl. For the sake of clarity, the structures shown in the formulas above are the non self-protonated form. However, as will be apparent to those of skill in the art upon reading and understanding the present patent application, including the attachments hereto, the above formulas are able to be easily converted to the corresponding self-protonated form.

In still another embodiment, a polymer according to any of Formulas (I) through (III) can be utilized to form a copolymer composition with any suitable biodegradable polymer (or corresponding monomer) composition described below.

In still another embodiment, m and n are independently integers selected from about 5 to about 5,000, or about 7 to about 2,500, or about 10 to about 1,000, or about 15 to about 500, or even about 25 to about 250. In still another embodiment, the polymers (or more accurately the homopolymers) of the present invention are low molecular weight polymers having molecular weights of about 500 grams per mole to about 10,000 grams per mole, or from about 750 grams per mole to about 9,000 grams per mole, or from about 1,000 grams per mole to about 8,000 grams per mole, or from about 1,250 grams per mole to about 7,500 grams per mole, or from about 1,500 grams per mole to about 6,000 grams per mole, or from about 2,000 grams per mole to about 5,000 grams per mole, or from about 2,500 grams per mole to about 4,000 grams per mole, or even from about 3,000 grams per mole to about 3,500 grams per mole. In another embodiment, polymers having molecular weights of about 500 grams per mole to about 20,000 grams per mole. Here, as well as elsewhere in the specification and claims, individual range limits can be combined to form additional non-disclosed ranges.

In still another embodiment, the copolymers of the present invention are low molecular weight copolymers having molecular weights of about 5,000 grams per mole to about 70,000 grams per mole, or from about 7,500 grams per mole to about 60,000 grams per mole, or from about 10,000 grams per mole to about 50,000 grams per mole, or from about 12,500 grams per mole to about 45,000 grams per mole, or from about 15,000 grams per mole to about 40,000 grams per mole, or from about 17,500 grams per mole to about 35,000 grams per mole, or from about 20,000 grams per mole to about 30,000 grams per mole, or even from about 22,500 grams per mole to about 27,500 grams per mole. Here, as well as elsewhere in the specification and claims, individual range limits can be combined to form additional non-disclosed ranges.

As discussed above, in one embodiment the present invention relates to the synthesis of polymers and/or copolymers of self-doped organic conducting polymers with biodegradable polymers and/or copolymers of polyaniline with biodegradable polymers. In one instance, the copolymer could be bi-copolymer or tri-polymers and/or multi-copolymers (organic conductive polymers with two different biodegradable polymers as hydrophilic and hydrophobic multi layers) that are self-assembling. In one embodiment, the polymers and/or copolymers could be “head-to-tail” and “branched and/or crown-type” copolymers (organic conductive polymers with biodegradable polymers). The morphology of the polymers and/or copolymers could be “core-shell” beads/fibers/thin films with various sizes from 20 nm to 500 microns.

Various synthesis methods are disclosed herein and include, but are not limited to, chemical and electrical-chemical synthesis, in-situ polymerization, vapor phase polymerization, and electro-magnetic induced polymerization, etc. Functional end-groups such as, 2-OH aniline, 3-OH aniline, are used to control the molecular weight during the self-doped polyaniline (SPAN) polymerization and the functional end-group will act as initiators to initialize the copolymerization with PCL and/or PLA monomers.

In one embodiment, the compounds of the present invention can be utilized to form conducting scaffolds for use in biomedical, or biological, applications. The conducting electrodes of the conducting scaffolds could be embedded electrodes, surface conducting electrodes, or any suitable combination thereof. The embedded electrodes can be made through multi-layers soft-lithography, core-shell beads/fibers electro-coating/spinning, coaxial electro-spinning, coaxial spinning (dry and/or wet), multi-layers in-situ polymerization and/or dipping, or any suitable combination thereof. The surface conducting electrodes can be made through multi-layers soft-lithography for hard-scaffolds; coaxial electro-spinning, coaxial spinning (dry and/or wet), multi-layers in-situ polymerization and/or dipping, or any suitable combination thereof for soft scaffolds. In still another embodiment, a combination of the above techniques such as multi-layer soft-lithography with coaxial electro-spinning methods can be utilized to produce hard-soft hybrid scaffolds. The conducting scaffolds can also have different categories such as hard, soft, or hard-soft hybrid scaffolds which can be used for cell proliferation and differentiation and they can be made by different processing. For example, a hard-scaffold can be made through multi-layer soft lithography, a soft-scaffold can be made through coaxial electro-spinning, and a hard-soft hybrid scaffold can be made through the combination of multi-layer soft-lithography with coaxial electro-spinning methods. Various preparation methods for the electrode connections can be utilized. Such method include, but are not limited to, thermal lamination, in-situ polymerization, vapor phase reaction, layer-by-layer dipping, spinning coating, electro-spinning, soft-lithography, ink-jetting, screen-printing, chemical etching, plastic wilding, etc.

Polyaniline (PANI) is a conducting polymer of the semi-flexible rod polymer family. Although it was discovered over 150 years ago, only recently has polyaniline captured the attention of the scientific community due to the discovery of its high electrical conductivity. Amongst the family of conducting polymers, polyaniline is unique due to its ease of synthesis, environmental stability, and simple doping/de-doping chemistry. Although the synthetic methods to produce polyaniline are quite simple, its mechanism of polymerization and the exact nature of its oxidation chemistry are quite complex. Because of its rich chemistry, polyaniline has been one of the most studied conducting polymers of the past 20 years.

Polymerized from the aniline monomer, polyaniline can be found in one of three idealized oxidation states: Leucoemeraldine—white/clear; emeraldine—green or blue; and pernigraniline—blue/violet. In the chemical reaction shown below x equals half the degree of polymerization (DP). Leucoemeraldine with n=l, m=0 is the fully reduced state. Pernigraniline is the fully oxidized state (n=0, m=1) with imine links instead of amine links. The emeraldine (n=m=0.5) form of polyaniline, often referred to as emeraldine base (EB), is either neutral or doped, with the imine nitrogens protonated by an acid. Emeraldine base is regarded as the most useful form of polyaniline due to its high stability at room temperature and the fact that upon doping the emeraldine salt form of polyaniline is electrically conducting. Leucoemeraldine and pernigraniline are poor conductors, even when doped with an acid.

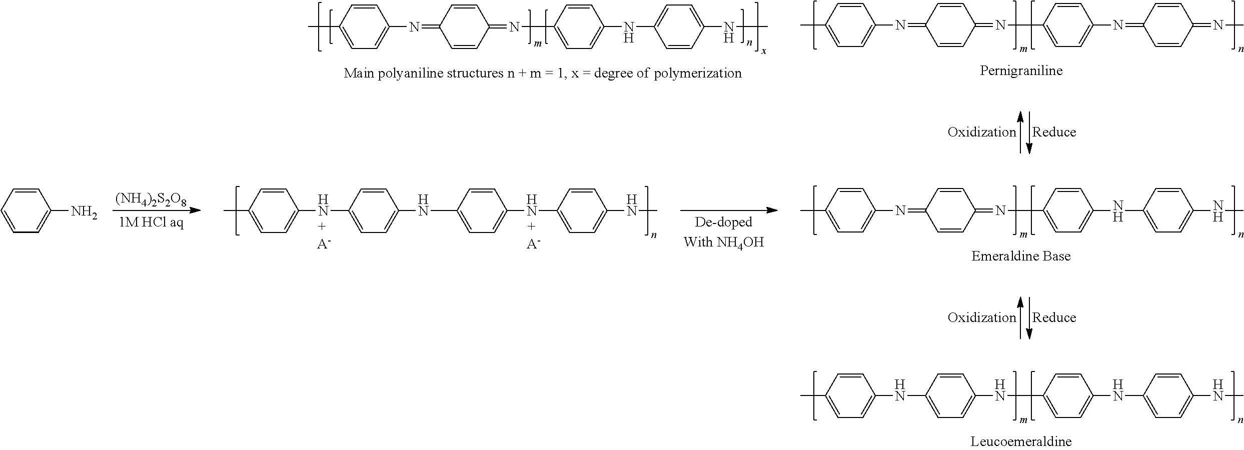

Many opportunities exist for the application of synthetic biodegradable polymers in the biomedical area particularly in the fields of tissue engineering and controlled drug delivery. Degradation is important in the biomedical area for many reasons. Degradation of the polymer implant means surgical intervention is not required for removal, thereby eliminating the need for a second surgery. In the role of tissue engineering biodegradable polymers can be designed such to approximate soft tissues, providing a polymer scaffold that can withstand resistance, provide a suitable surface for cell attachment and growth and degrade at a rate that allows the load to be transferred to the new tissue. In the field of controlled drug delivery biodegradable polymers offer tremendous potential as a basis for drug delivery, either as a drug delivery system alone or in conjunction to functioning as a medical device.

Once implanted a biodegradable device should maintain its mechanical properties until it is no longer needed and then be absorbed by the body leaving no trace. The backbone of the polymer is hydrolytically unstable. That is, the polymer is unstable in a water based environment. This is the prevailing mechanism for the polymers degradation. This occurs in two stages. First, water penetrates the bulk of the device, attacking the chemical bonds in the amorphous phase and converting long polymer chains into shorter water-soluble fragments. This causes a reduction in molecular weight without the loss of physical properties as the polymer is still held together by the crystalline regions. Water penetrates the device leading to metabolization of the fragments and bulk erosion. Second, surface erosion of the polymer occurs when the rate at which the water penetrating the device is slower than the rate of conversion of the polymer into water soluble materials. Biomedical engineers can tailor a polymer to slowly degrade and transfer stress at the appropriate rate to surrounding tissues as they heal by balancing the chemical stability of the polymer backbone, the geometry of the device and the presence of catalysts, additives or plasticizers.

Given the above, the following chemical compounds fall within the scope of self-doped polyaniline compounds that are within the scope of the present invention. Additionally, any one or more of the following compounds can be utilized to form copolymer compounds with one or more suitable biodegradable polymers. Some exemplary polymer compounds are also detailed below. However, the present invention is not limited thereto.

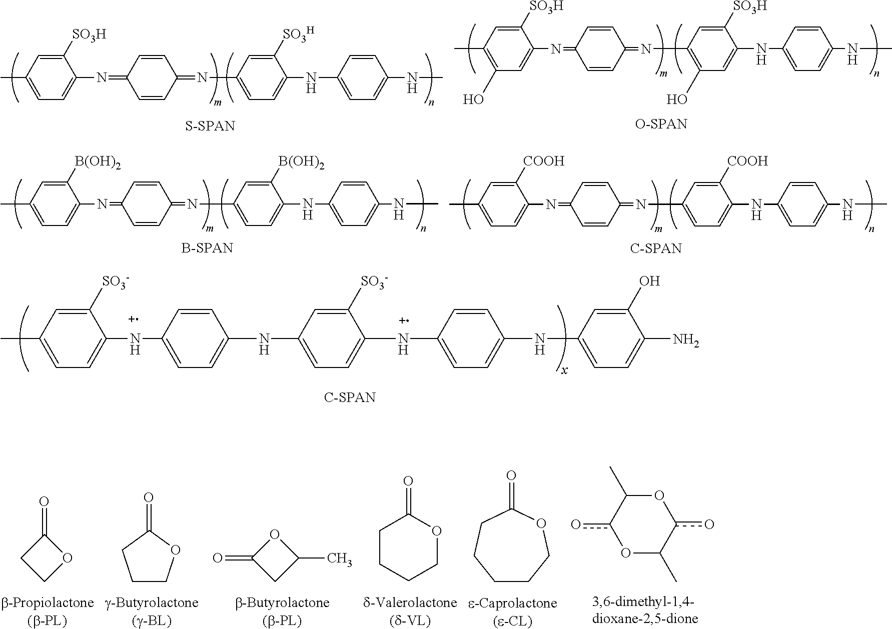

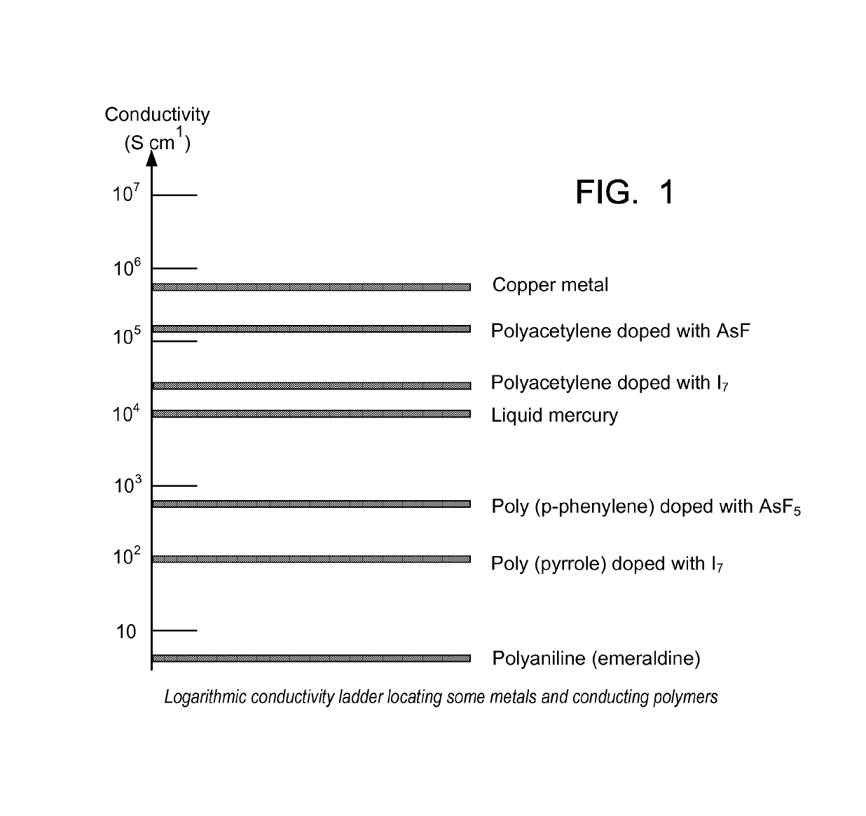

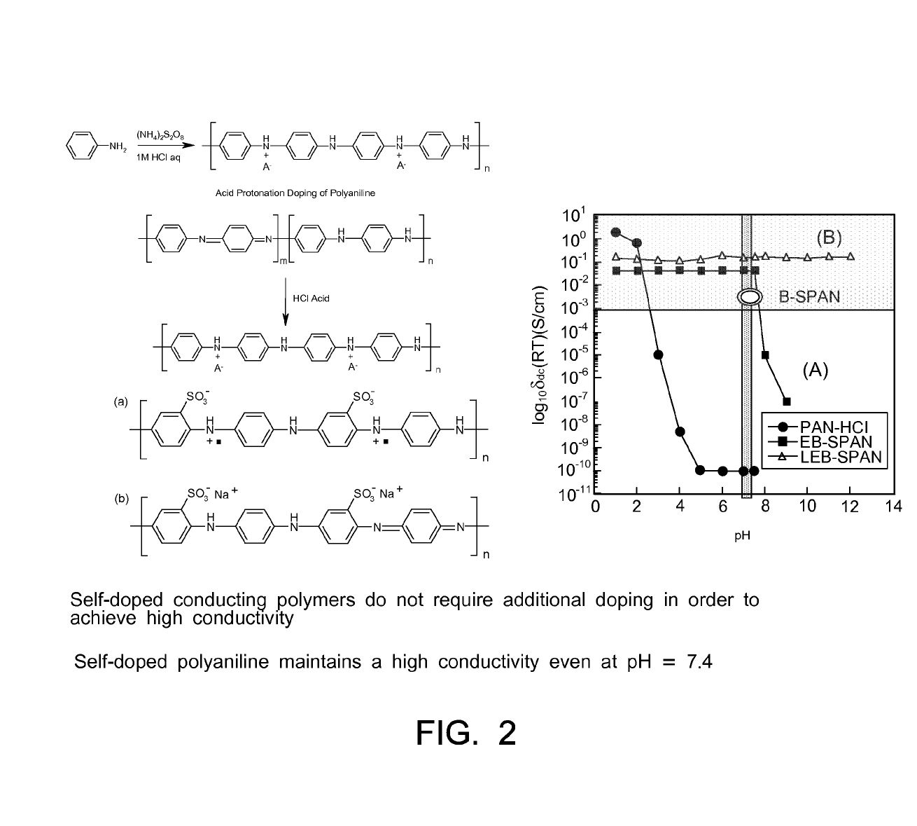

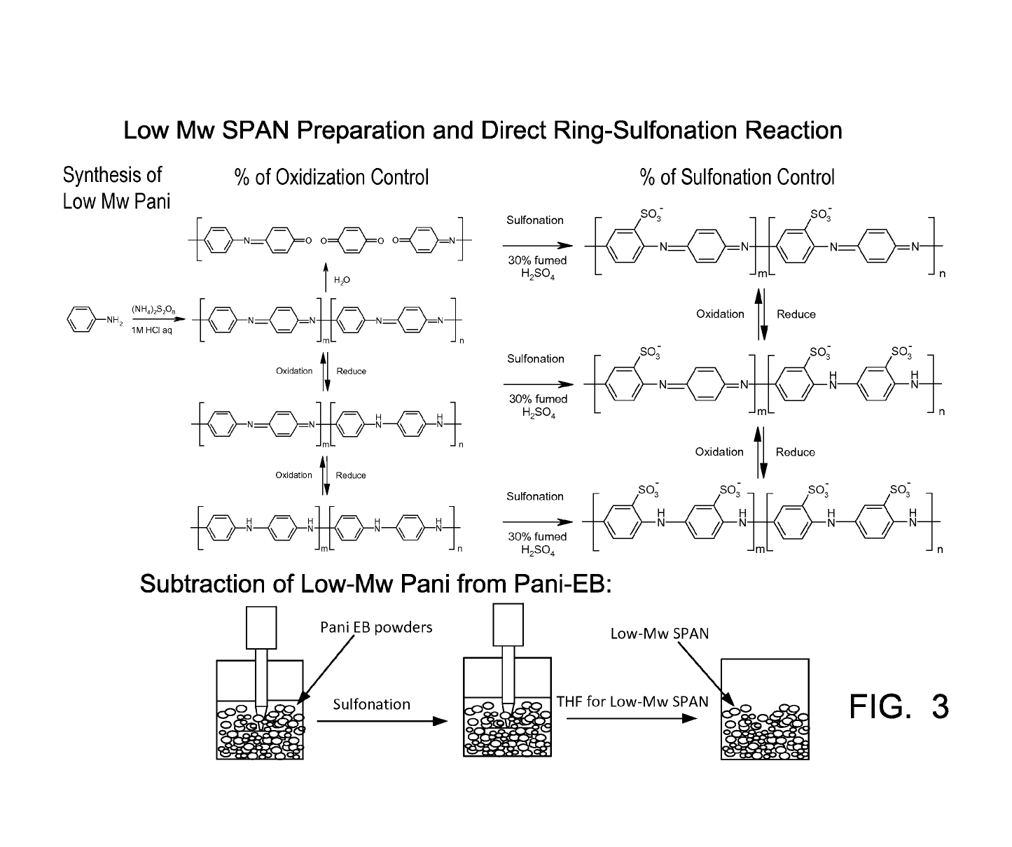

As noted above, FIG. 1 is a graph detailing the conductivities of various doped polymer compositions as compared to some common conductive materials, while FIG. 2 is a graph detailing the conductivities of various polymer compounds at various pHs. Turning to FIG. 3, FIG. 3 is a synthesis route according to one embodiment of the present invention for producing a low molecular weight SPAN in according with the present invention.

In one instance, the synthesis route of FIG. 3 is used to synthesize a SPAN compound in accordance with the present invention using aniline as a monomer and ammonium persulfate (APS) as a catalyst. In order to control the molecular weight of polyaniline, an additional amount APS (up to 10×) and hydrazine (N₂H₄) are used change the synthesized polyaniline oxidation states from pernigraniline through emeraldine to lecu-emeraldine as indicated on the equation on the left side of FIG. 3. In this example, it is found that the molecular weight of the polymer is reduced from a weight average molecular weight of 50,000 to about 5,000 after three to five processing runs.

The degree of sulfonation can also be controlled through the sulfonation processing. As an example, less than 50 percent sulfonation can be achieved if one adds fumed sulfuric acid (H₂SO₄) at pernigraniline oxidation stage, whereas typically the degree of sulfonation is about 30 percent. Less than 75 percent sulfonation can be achieved if one adds the fumed sulfuric acid (H₂SO₄) at emeraldine oxidation stage, whereas typically the degree of sulfonation is about 50 percent. Less than 100 percent sulfonation can be achieved if one adds the fumed sulfuric acid (H₂SO₄) at leco-emeraldine oxidation stage, whereas typically the degree of sulfonation is about 70 percent.

Furthermore, in one embodiment the present invention permits one to control the amount of “doping” in the compounds of the present invention. As can be seen from the examples detailed in FIG. 3 the percentage of oxidation in the repeating polyaniline structure can be controlled. Also, the method of FIG. 3 permits control of the percentage of sulfonation of the polyaniline structure. It should be noted that the three embodiments on the right hand portion of FIG. 3 have theoretical sulfonation that range from 50 percent, to 75 percent, to even 100 percent of the aromatic rings of the repeating polyaniline units. Here, as well as elsewhere in the specification and claims, individual range limits can be combined to form additional non-disclosed ranges.

In reality, the realized amount of sulfonation may be less then the theoretical amounts shown in FIG. 3 (as is discussed above). In one embodiment, the method of FIG. 3 can be done in via one-pot solution polymerization using either THF or xylene as a suitable solvent.

Given the above, the amount of doping on any of the aromatic rings of the repeating polyaniline units of the polymer and/or copolymer compositions of the present invention range from about 10 percent to 100 percent, or from about 15 percent to about 99 percent, or from about 20 percent to about 95 percent, or from about 25 percent to about 90 percent, or from about 30 percent to about 85 percent, or from about 35 percent to about 80 percent, or from about 40 percent to about 75 percent, or from about 45 percent to about 70 percent, or from about 50 percent to about 65 percent, or even from about 55 percent to about 60 percent. Here, as well as elsewhere in the specification and claims, individual range limits can be combined to form additional non-disclosed ranges.

Given the above, the amounts of doping convey the percentage of aromatic rings of the repeating polyaniline units that contain at least 1 dopant group. Such groups include, but are not limited to —SO₃M, —R₉SO₃M, —OCH₃, —CH₃, —C₂H₅, —F, —Cl, —Br, —I, —N(R₉)₂, —NHCOR₉, —OH, —O⁻, —SR₉, —OR₉, —OCOR₉, —NO₂, —COOH, —COOR₉, —COR₉, —CHO, —CN, —SO₃H, —B(OH)₂, —SO₃⁻ and B(R₁₀)₂ wherein R₉ is a C₁ to C₈ alkyl, aryl or aralkyl group, R₁₀ is a H, a C₁ to C₈ alkyl, aryl or aralkyl group, C₁ to C₈ straight or branched alkyl, a C₁ to C₈ alkyl, aryl or aralkyl group that contains one or more heteroatoms selected from N, S or O, and wherein M is a H or an unsubstituted or substituted ammonia of the formula NA₁A₂A₃ and A₁, A₂ and A₃ are independently selected from H and C₁ to C₈ straight or branched alkyl. These groups are discussed in greater detail above as to how they relate to the aromatic rings of the repeating polyaniline units. In another embodiment, the aromatic rings in the repeating polyaniline units of the polymers and/or copolymers of the present invention have at least two dopant groups on each aromatic ring, at least three dopant groups per aromatic ring, or even four dopant groups per aromatic ring. Here, as well as elsewhere in the specification and claims, individual range limits can be combined to form additional non-disclosed ranges.

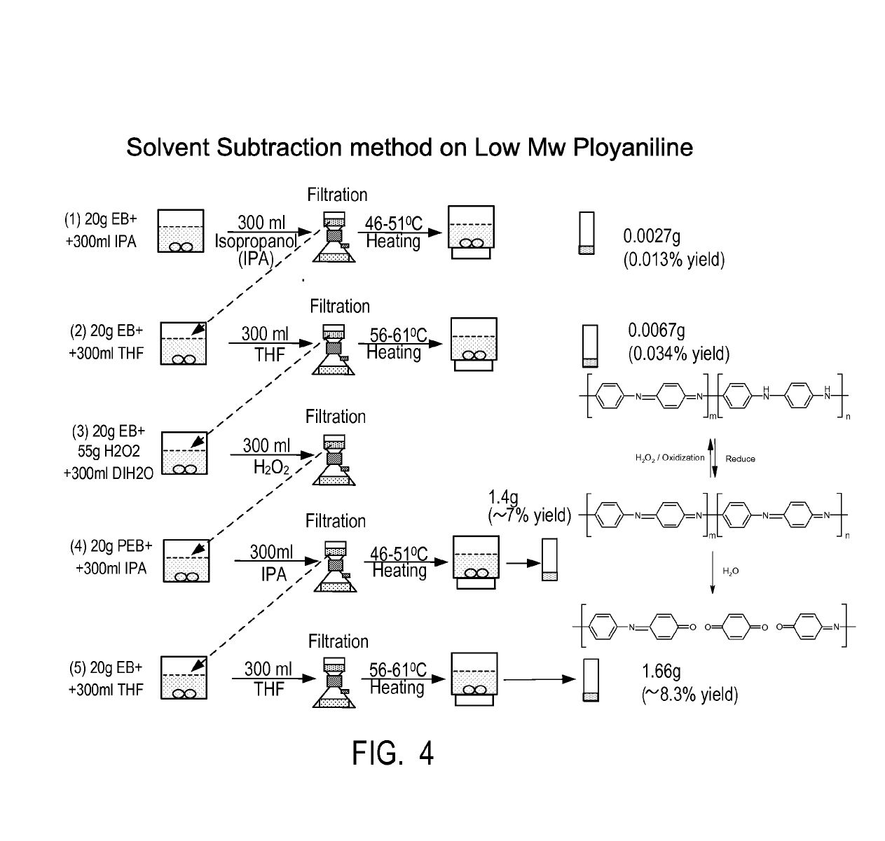

Turning to FIG. 4, FIG. 4 is an illustration of a synthesis route according to one embodiment of the present invention for producing low molecular weight polyaniline and SPAN utilizing direct solvent subtraction. Using the process disclosed in FIG. 4, the following exemplary production method can be used to produce polyaniline and/or SPAN. It should be noted that the present invention is not limited to any of the examples disclosed herein. Rather, the present invention should be broadly construed.

Twenty grams of polyaniline emeraldine base (EB) powder, which is synthesized chemically with an average molecular weight of 50,000, is dissolved and/or dispersed in 300 mL of isopropyl alcohol (IPA) solvent. After a filtration with Whatman Grade No. 4 Filter Paper the solution is placed in a 500 mL beaker and heated to a temperature in the range of about 46° C. to about 51° C. overnight (i.e., for about 8 to about 12 hours). After this, 0.0027 grams of low molecular weight of polyaniline powder, with a yield of 0.013 percent, is obtained (see Step (1) of FIG. 4). The filter cake from above processing is then dissolved in 300 mL of THF. After repeating the above filtration process 0.067 grams of low molecular weight polyaniline powder, with a yield of 0.084 percent, is obtained (see Step (2) of FIG. 4). This material can then be modified in accordance with Step (3) through (5) of FIG. 4 based on the parameters disclosed therein. The reaction at the right side of FIG. 4 discloses the various compounds that can be achieved once the SPAN is subjected to, for example, the reaction detailed in Step (3) of FIG. 4.

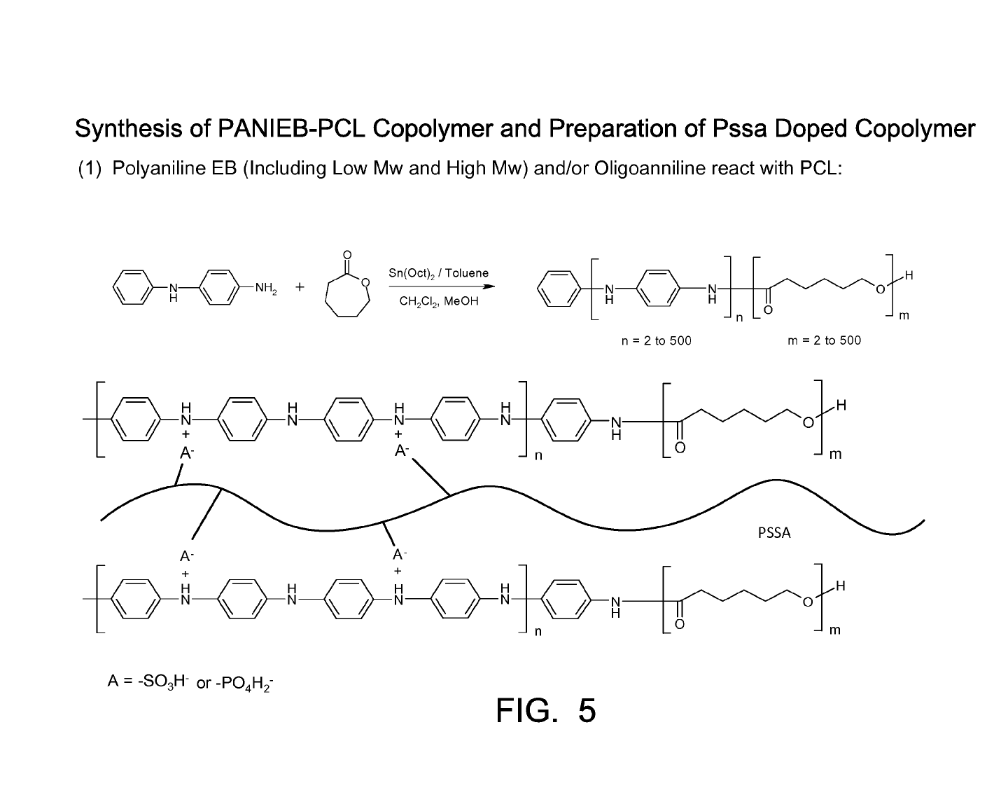

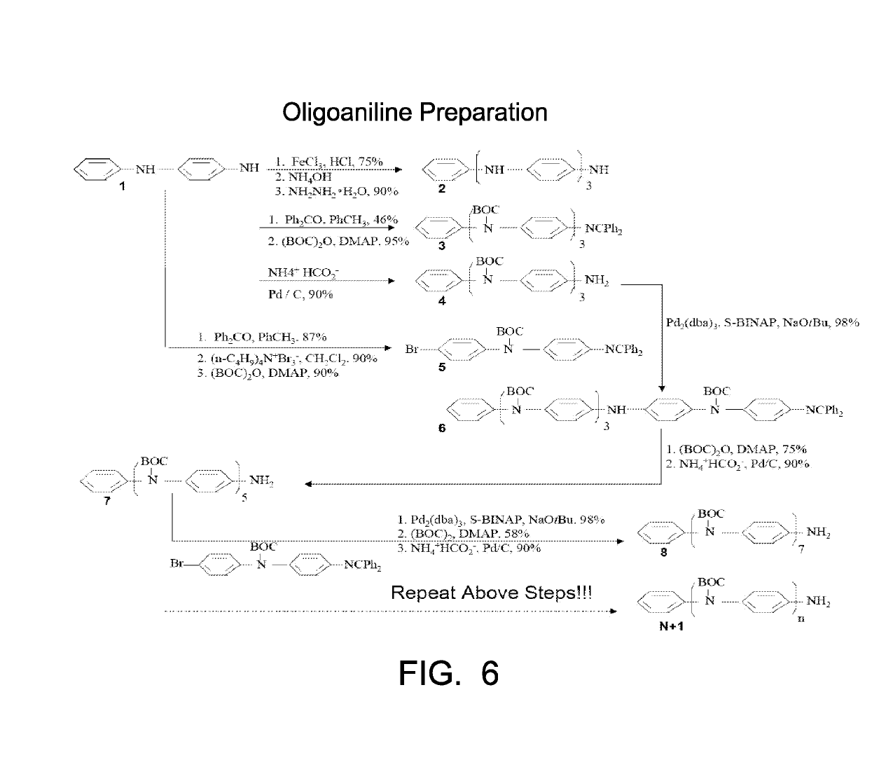

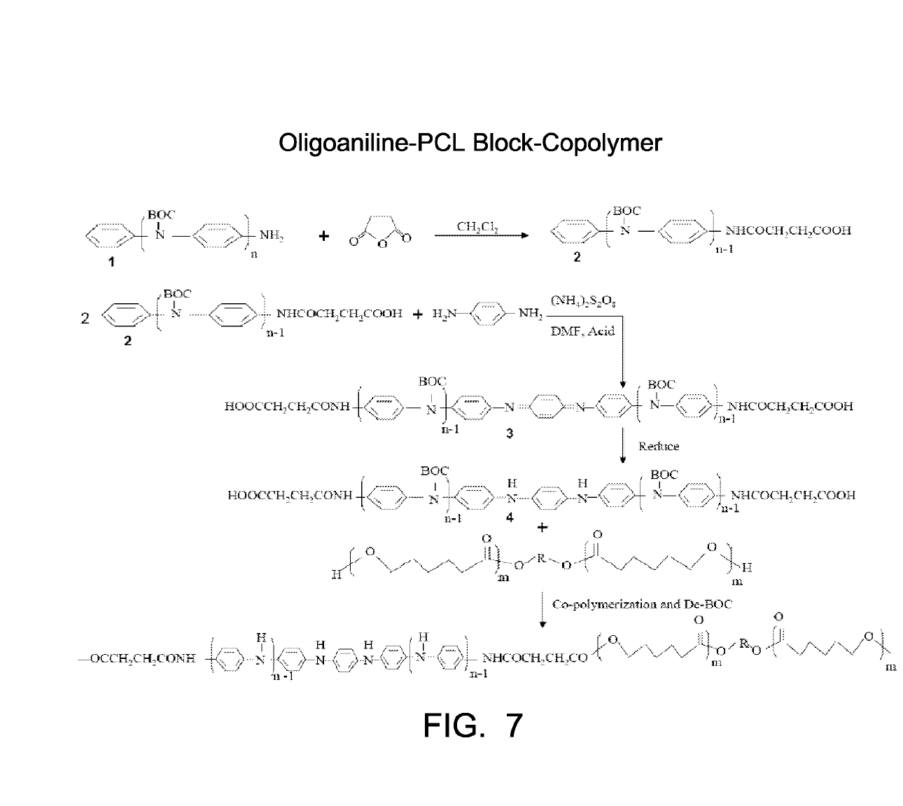

Turning to FIG. 5, FIG. 5 discloses a synthesis route for the production of a PANI EB-PCL copolymer and the preparation of a PSSA-doped copolymer. Turning to FIGS. 6 and 7, FIG. 6 discloses one suitable synthesis route for the synthesis of aniline tetramer and oligomers. In one embodiment, the aniline tetramer is synthesized by oxidizing the coupling method. The N-phenyl-1,4-phenylenediamine is re-crystallized from water. Then, N-phenyl-1,4-phenylenediamine (18.4 grams, 0.10 moles) is dispersed in 500 mL 0.1 N HCl while stirring vigorously. The solution of the oxidizing reagent, 50 mL of H₂O with FeCl₃.6H₂O (27.0 grams, 0.10 moles) contained therein is added in one portion. A green, thick and sluggish product forms immediately and the reaction continues at room temperature for about 2 hours. The product is collected by suction filtration and washed with 0.1 N HCl (100 mL×5). At this stage the product demonstrates a very fine fiber, so the filtration speed is slow. Then, the blue-green product is suspended in 500 mL 0.1 N ammonium hydroxide for 4 hours. The de-doped tetramer is brown in color. The product is collected by suction filtration, washed with H₂O (100 mL×5) and dried under dynamic vacuum for 24 hours. The resulting aniline tetramer is purified by silica chromatography using ethyl acetate as the eluting solvent (R.F.=0.6). The final product is an emeraldine base (EB) form of the aniline tetramer in which 50 percent of the backbone nitrogen possesses imine bonds. The aniline tetramer leuco form (100 percent of the backbone nitrogen atoms are in reduced amine bonds) is obtained by treating the tetramer EB (0.366 grams, 0.01 moles) with 10 mL hydrazine in 10 mL ethanol under nitrogen for 24 hours. The product is re-crystallized from 1,4-dioxane as a white crystal and the yield is 90 percent as described in the above equation from Compound 1 to Compound 2, tetramer aniline. Following the above reaction, octomer aniline, as well as higher molecular weight oligo aniline are produced with reasonable yields. The oligoaniline-PCL block copolymer is produced using, in one embodiment, the reactions detailed in FIG. 7.

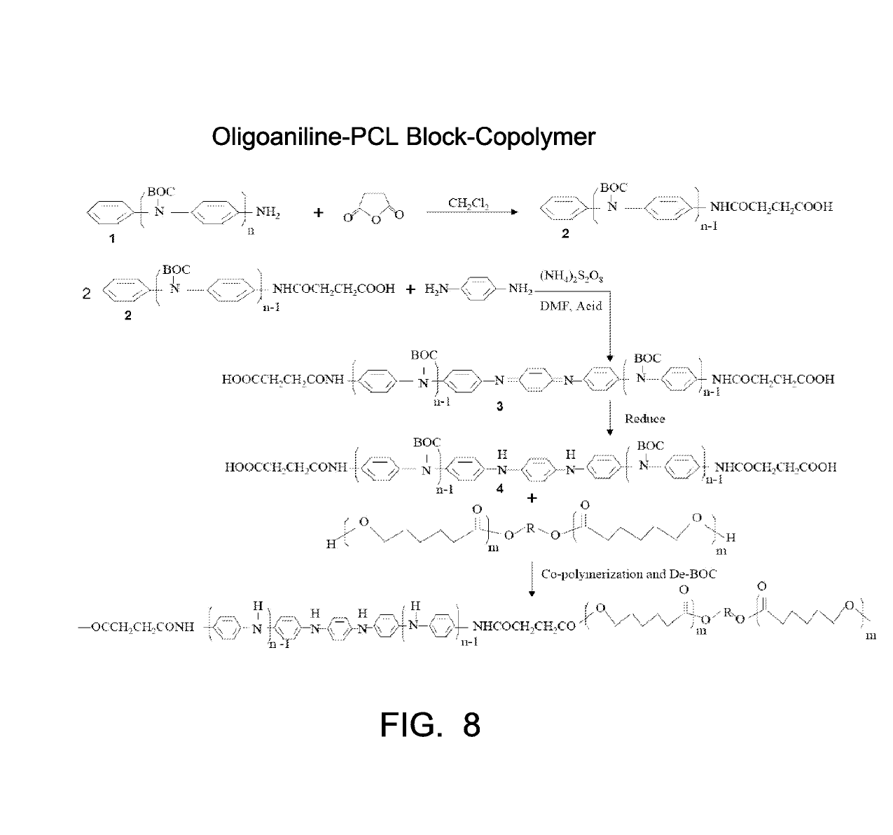

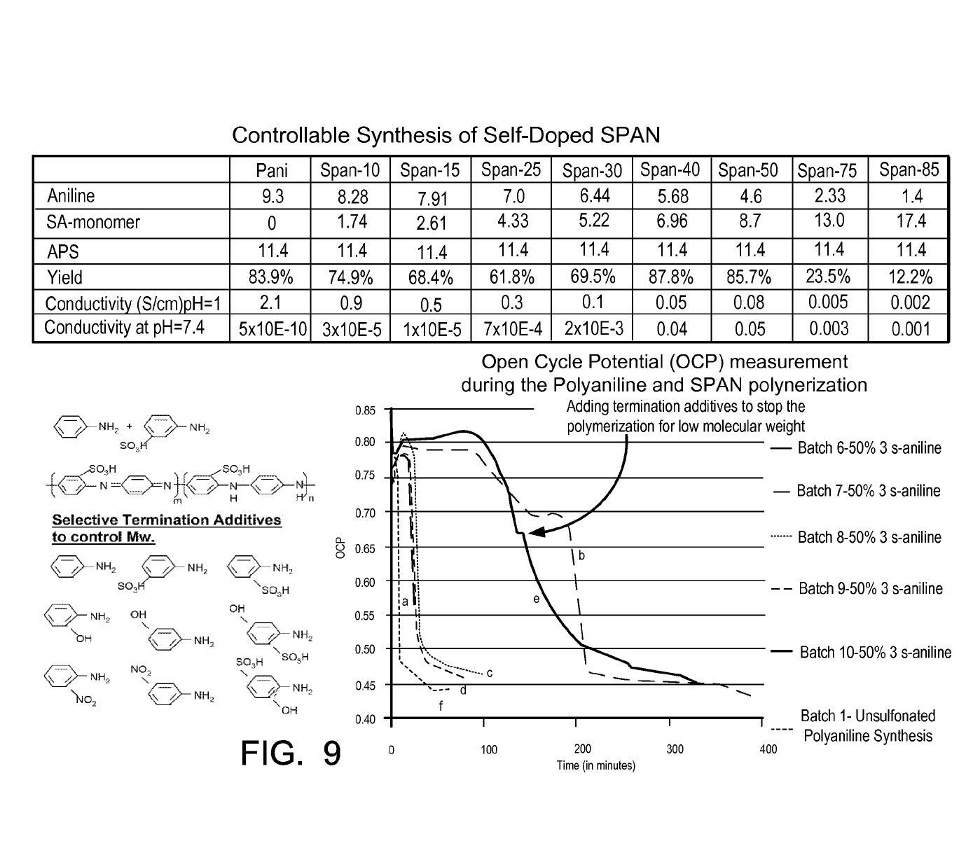

Turning to FIG. 8, FIG. 8 is an illustration of various synthesis routes in accordance with multiple embodiments of the present invention that are utilized to produce various doped PANI compounds in accordance with the present invention. Turning to FIG. 9, FIG. 9 contains a table detailing a variety of sulfonated polyaniline compounds (S—SPAN) with varying amounts of doping. In the examples of FIG. 9 the numbers in the top row represent the amount, in percentages, or molar percentage, of sulfonated aromatic rings in the repeating polyaniline units. Thus, PANI has no sulfonation whereas Span-85 has 85 percent of its aromatic ring structures substituted with a —SO₃H group. The products shown in the table of FIG. 9 have increasing conductivity as the amount of sulfonation increases. Additionally, the compounds of the table of FIG. 9 are self-protonated and retain their conductivity even at biological pH. Also disclosed in FIG. 9 are various compounds that can be utilized as termination additives to permit the selective control of the molecular weight of the SPAN compounds disclosed in FIG. 9.

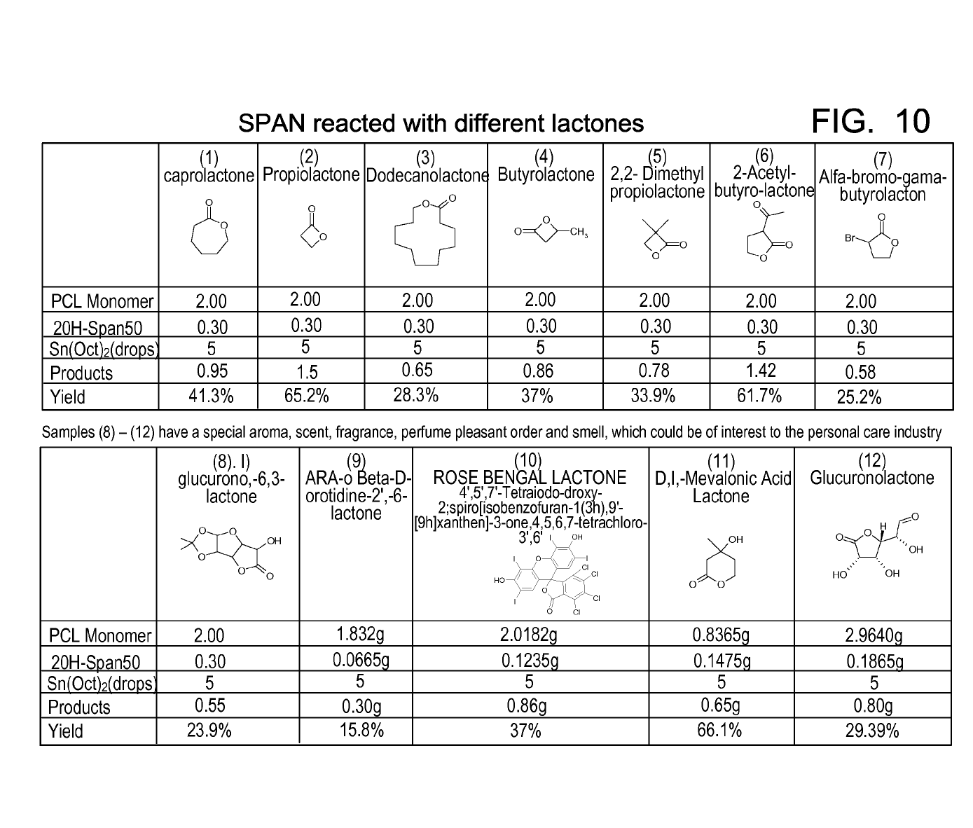

Turning to FIG. 10, FIG. 10 discloses a synthesis method for producing boronic SPAN (B-SPAN) which can be synthesized by a variety of methods including, but not limited to, chemical polymerization, in-situ polymerization, vapor phase polymerization and electro-chemical polymerization. In one embodiment, B-SPAN can be synthesized using 3-aminophenylboronic acid (0.1488 grams) that is dissolved in a 20 mL solution of 10 M fructose and 40 mM sodium fluoride (solution A). Next, 0.5 mL of ammonium persulfate aqueous solution (40 mM) is added to solution A dropwise with stirring for 16 hours. The product is collected by the Buchner funnel and washed carefully with a 10 M fructose solution (20 mL×3). The product is suspended in 1 mL fructose solution. FIG. 10 also details the conductivity of various compounds.

Given the above, the present invention relates in one instance to copolymer compositions that are made using a suitable catalyst and monomer. Suitable catalysts for use in conjunction with the present invention include, but are not limited to, Sn(Oct)₂, Ti(OnBu)₄, Al(OiPr)₃, AlEt₃, or suitable combinations of two or more thereof. Additionally, suitable monomer compositions include, but are not limited to, those compounds shown above as well as the following monomers:

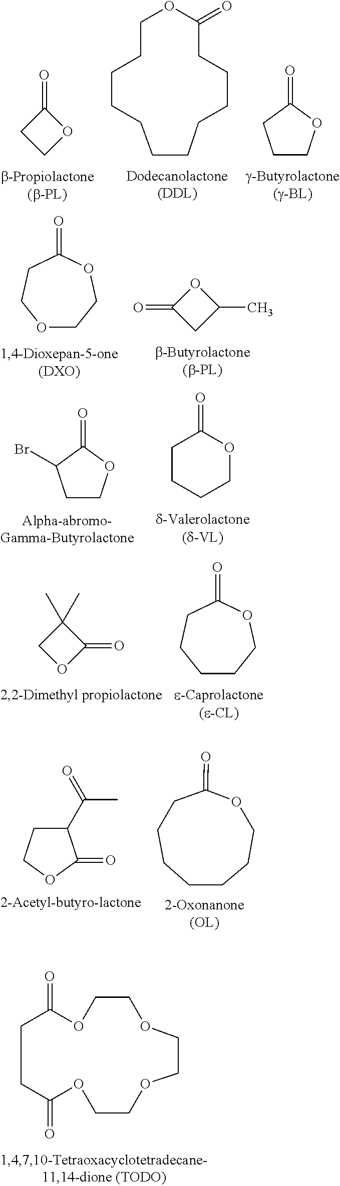

FIG. 10 is a table listing a variety of examples that detail co-polymer compositions made in accordance with the present invention.

Given the above, the copolymer compositions of the present invention can be made from a conducting polymer such as, S—SPAN, O—SPAN, B-SPAN, C—SPAN, as well as 2-OH, or 3-OH aniline end-capped SPANs (see above), and biodegradable copolymers such as β-PL, γ-BL, β-PL, δ-VL, ∈-CL, and 3,6-dimethyl-1,4-dioxane-2,5-dione shown above.

FIG. 10 discloses examples where SPAN is reacted with different lactone monomers to yield various co-polymer compositions within the scope of the present invention. The SPAN in the examples of FIG. 10 is 2-OH SPAN with a doping amount of 50 percent of the repeating aromatic structures in the repeating polyaniline portion of the molecule being doped. The amounts of the reactants listed in the table of FIG. 10 are given in grams unless otherwise stated.

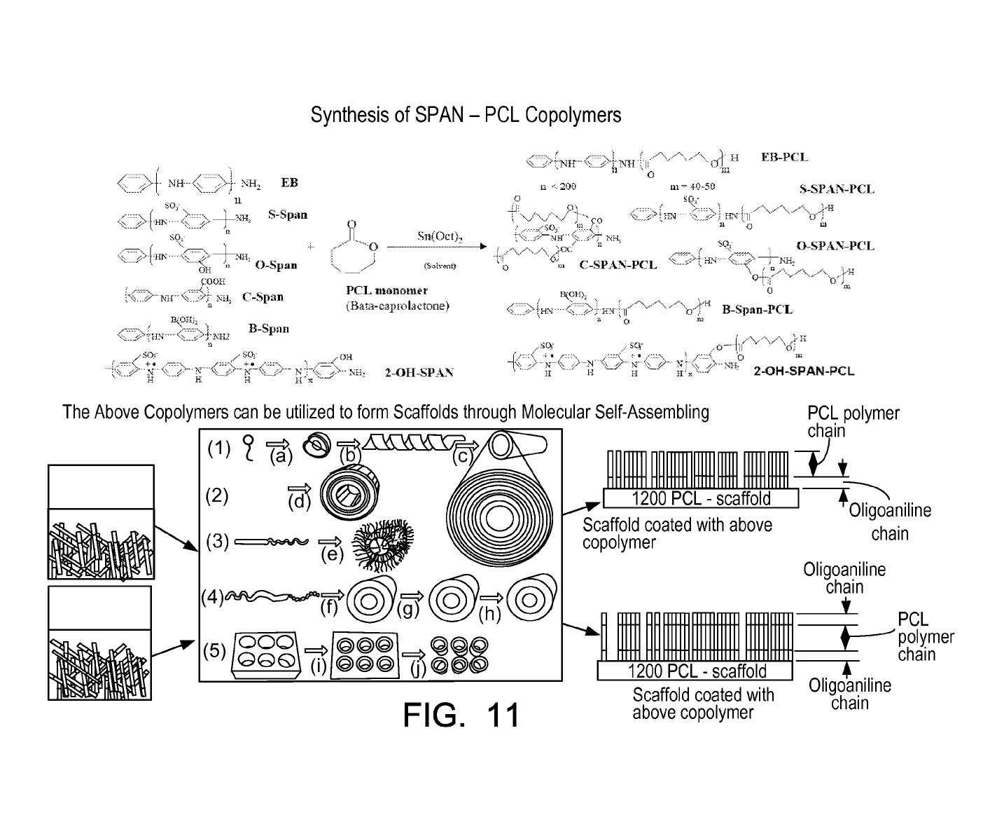

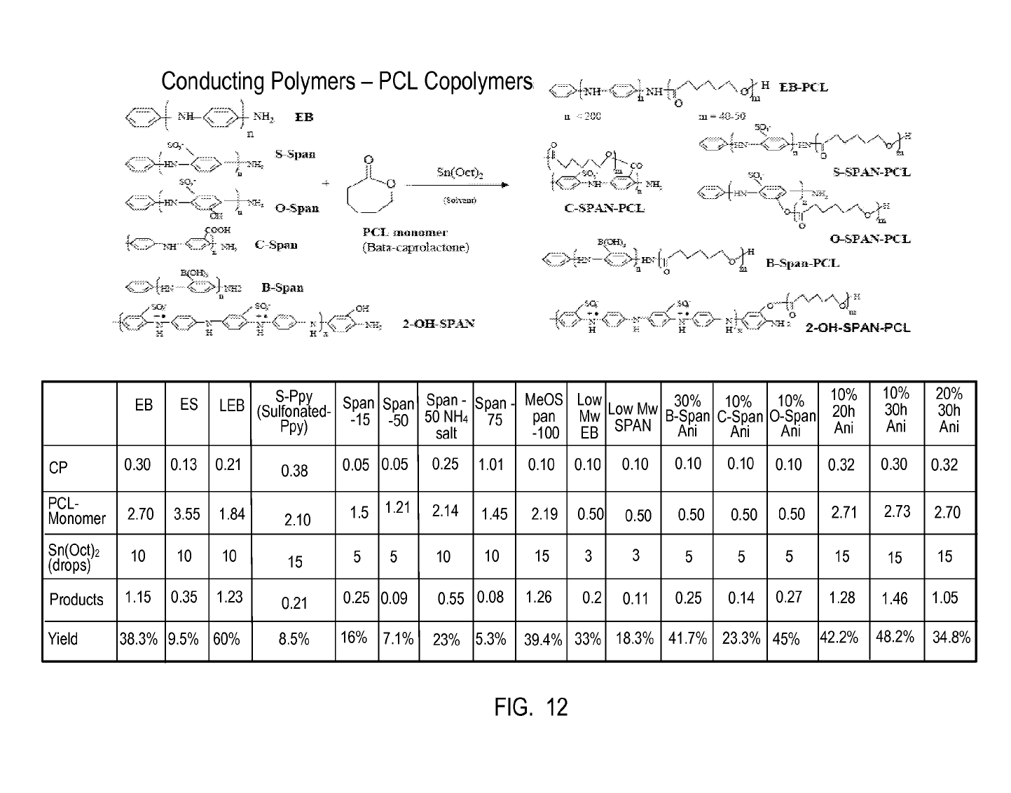

FIG. 11 discloses various copolymer compounds formed from a SPAN compound with, for example, a beta-caprolactone PCL monomer. FIG. 11 also discloses how to form tissue scaffolding from such compounds. Turning to FIG. 12, FIG. 12 discloses various conductive copolymer compositions formed in accordance with the present invention, including some that are conductive polyester co-polymer compositions, where ES stands for emeraldine salt. The contained in FIG. 12 details the various amounts of the reactants that are utilized to form the compositions detailed therein. Again, unless otherwise noted, the amounts given are in grams.

### Synthesis of Tetramer-PCL Copolymer:

Initially, 0.6 grams of aniline tetramer (EB form) is added to a triple flame-dried 50 mL round-bottom flask with 10 mL dry toluene. Next, 9.1 mL of distilled ∈-caprolactone and 44 mg tin (II) 2-ethylhexanoate (the catalyst) to flask. This mixture is then stirred until reactant are homogenous. This mixture is then subjected to a flash reaction in a flask with nitrogen, the flash is then immersed in 120° C. oil bath with magnetic stirring. This reaction is permitted to proceed for 24 hours under N₂. After 24 hours, the reaction flask is permitted to cool to room temperature. The resulting product is dissolved with 10 mL tetrahydrofuran and the resulting solution is poured into a 100 mL of hexane to precipitate the desired product. The THF and hexane steps are repeated three times. Finally, the product is filtered out by Buchner funnel and dried with a dynamic vacuum for 24 hours. The product obtained is an aniline tetramer-PCL (8.76 grams, yield is about 88 percent).

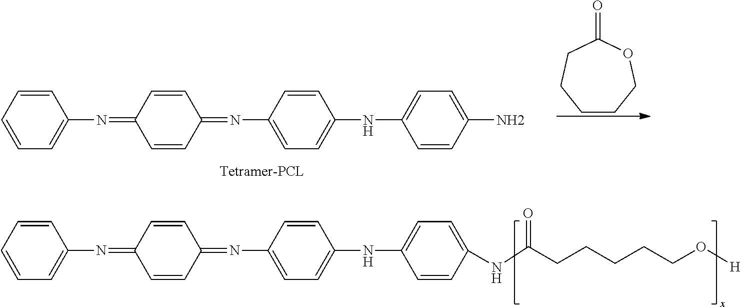

Although the tetramer-PCL has a conductivity of less than 10 E⁻⁶ S/cm, it is possible to achieve a high conductivity with an oligomer aniline as an octamer or higher, i.e., n>8.

### Synthesis of Aniline Tetramer-Polycaprolactone:

In this example, aniline tetramer is used in the synthesis of copolymer with polycaprolactone. Aniline tetramer (0.182 grams, 0.5 mmoles), caprolactone (2.85 grams, 25 mmoles), and tin (II) ethylhexaone (20.3 mg, 0.05 mmoles) are added into a flame-dried round bottom 25 mL flask. The flask is immersed in a 120° C. oil bath for 24 hours with magnetic stirring under nitrogen. As the reaction took place, the reaction mixture gradually became thicker. The product is cooled to room temperature and then dissolved in a 20 mL dichloromethane, precipitated in 200 mL methanol, and collected by reduced pressure filtering. The dichloromethane-methanol dissolving precipitation process is repeated three times. The product is then dried under dynamic vacuum at room temperature for 24 hours. The final product is a free standing blue powder.

### Synthesis of Aniline Tetramer-PLA Copolymer:

The 3,6-dimethyl-1,4-dioxane-2,5-dione is re-crystallized from ethyl acetate and the crystal is dried in dynamic vacuum for 24 hours. Aniline tetramer (0.364 grams, 1 mmole) is dissolved in 5 mL anhydrous tetrahydrofuran in a 50 mL round bottom flask. Then, 3,6-dimethyl-1,4-dioxane-2,5-dione (3.6 grams, 25 mmoles) and tin (II) ethylhexanoate (13.5 mg, 0.03 mmoles) are added into the flask. The flask is connected to a Schlenk line. The flask is then purged with nitrogen three times. Then the temperature is raised to 60° C. and the tetrahydrofuran is removed thoroughly by careful vacuuming. Then the flask is immersed in the 120° C. oil bath under nitrogen environment. After 24 hours, the reaction flask is cooled to room temperature. Next, 20 mL dichloromethane is added to dissolve the product; then the dichloromethane solution is added to a flask containing 200 mL cold methanol under a strong stir. Initially, a sticky glue-like product starts to form in the methanol and the product becomes a transparent solid after 4 hours. The product is collected by suction funnel and washed with methanol (100 mL×3). Then, the product is dried in dynamic vacuum for 24 hours.

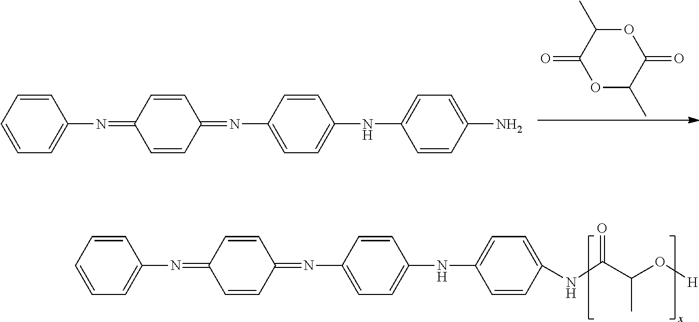

Although in this example, the above tetramer-PCL has a conductivity of less than 10 E⁻⁶ S/cm, it is possible to achieve a high conductivity with an oligomer aniline as an octamer or higher, i.e., n>8.

### Synthesis of the Aniline-Tetramer-Polylactic Acid Copolymer:

The monomer 3,6-dimethyl-1,4-dioxane-2,5-dione is re-crystallized from ethyl acetate. Aniline tetramer (0.145 grams, 0.4 mmoles), monomer (2.88 grams, 20 mmoles), and Sn(Oct)₂ (40.5 mg, 0.1 Kmoles) are added to a flame-dried round bottom 20 mL flask. The flask under a nitrogen environment is immersed in a 120° C. oil bath for 24 hours with magnetic stirring. Under this temperature, the monomers melted, and the polymerization reaction takes place. The aniline tetramer is dissolved in the melted 3,6-dimethyl-1,4-dioxane-2,5-dione to provide a dark purple solution. When the reaction is completed, the bulk mixture becomes a dark-purple solid. The product is cooled to room temperature and then dissolved in 20 mL tetrahydrofuran. It is then precipitated in 200 mL methanol and collected by suction filtering. The tetrahydrofuran-methanol dissolving precipitation process is repeated three times. The product is dried under dynamic vacuum at room temperature for 24 hours.

### Synthesis of EB-PCL Copolymer:

First, 0.5 grams of EB is added to a triple flame-dried 25 mL round-bottom flask. Next, 15 mL of distilled ∈-caprolactone and 40.5 mg of tin (II) 2-ethylhexanoate is added to flask. Next a flash reaction flask with nitrogen is conducted and the flask immersed in a 120° C. oil bath with magnetic stirring. This reaction is permitted to proceed for 24 hours under N₂. After 24 hours the flask is permitted to cool to room temperature. The resulting product is dissolved with 100 mL dichloromethane and the resulting solution is poured into 500 mL of methanol to precipitate the product. The dichloromethane and methanol steps are repeated and then the resulting product is filtered out by Buchner funnel. The product is then dried under a dynamic vacuum for 24 hours. The product obtained is an EB-PCL compound in an amount of 12.2 grams (yield is about 79 percent).

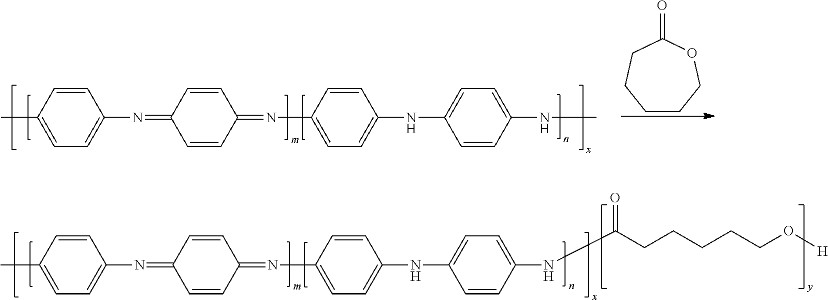

### Synthesis of Polyaniline-Polycaprolactone Copolymer:

Polyaniline-EB (0.5 grams, 8.3 μmoles) is added to a triple flame-dried 25 mL round bottom flask which is connected to a Schlenk line. The flask is purged by nitrogen five times and heated to 120° C. under vacuum for 12 hours. When the flask is cooled to room temperature, 15 mL of freshly distilled ∈-caprolactone (15.45 grams, 0.135 moles) and 40.5 mg tin (II) 2-ethylhexanoate are added to the flask by syringe, followed by a nitrogen purge. Then, the flask is immersed in a 120° C. oil bath with magnetic stirring for 24 hours under a nitrogen environment. After 24 hours, the flask is cooled to room temperature. A portion of 100 mL dichloromethane is added to the flask to dissolve the product. The solution is then poured into a beaker with 500 mL of methanol under magnetic stirring and a blue solid starts to precipitate in the methanol. After stirring in methanol for two hours, the product is collected by a Buchner funnel and washed by methanol (100 mL×3). The final product is a blue powder.

### Synthesis of EB-PLA Copolymer:

The 3,6-dimethyl-1,4-dioxane-2,5-dione is re-crystallized from ethyl acetate and the crystal is dried in dynamic vacuum for 24 hours. EB (0.1 grams) is charged in a flame dried 50 mL round bottom flask which is connected to a Schlenk line. The flask is purged by nitrogen five times and heated to 120° C. under vacuum for 24 hours. Then, 3,6-dimethyl-1,4-dioxane-2,5-dione (3.6 grams, 25 mmoles) and tin (II) ethylhexanoate (13.5 mg, 0.03 mmoles) are added into the flask. The flask is purged by nitrogen three times. The flask is immersed in the 120° C. oil bath under nitrogen environment. After 48 hours, the reaction flask is cooled to room temperature. Next, 20 mL of dichloromethane is added to dissolve the product; then the dichloromethane solution is added to a flask containing 200 mL of cold methanol under strong stirring. Initially, a sticky glue-like product starts to form in the methanol and the product becomes a transparent solid after 4 hours. The product is collected by suction funnel and washed with methanol (100 mL×3). Then, the product is dried under a dynamic vacuum for 24 hours.

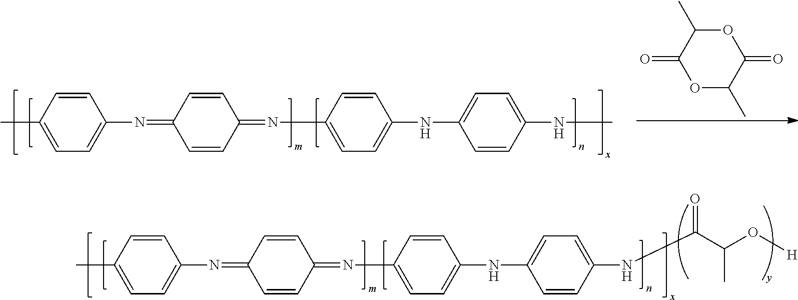

### Synthesis of the Polyaniline-Polylactic Acid Copolymer:

A dry polyaniline emeraldine base (0.5 grams, 8.3 μmoles) is added to a flame-dried 25 mL round-bottom flask which is connected to a Schlenk line. The flask with the polyaniline is purged by nitrogen five times and heated to 120° C. under vacuum for 12 hours to further dry same. When the flask is cooled to room temperature, the monomer 3,6-dimethyl-1,4-dioxane-2,5-dione (7.20 grams, 0.05 moles) and Sn(Oct)₂ (40.5 mg, 0.1 μmoles) are added to the flask, followed by a triple-nitrogen purge. Then the flask is immersed in a 120° C. oil bath with magnetic stirring for 24 hours under a nitrogen environment. After 24 hours, the flask is cooled to room temperature. Then, a 100 mL of tetrahydrofuran is added to the flask to dissolve the product to yield a blue solution. The solution is poured into a beaker with 500 mL of methanol under magnetic stirring. A blue solid powder starts to precipitate in the methanol. After 2 hours of stirring in methanol, the product is collected by a Buchner funnel and washed with methanol (100 mL×3). The final product is a shiny blue powder.

### Synthesis of SPAN-PCL Copolymer:

SPAN (0.52 grams from Nitto Chemical) and 5 mL of a tetrabutylammonium hydroxide (1.0 M H₂O solution) are combined together. This mixture is gradually heated to 95° C. Next, an evaporator is used to remove most of the remaining water. The resulting brown tar is dissolved with 10 mL dichloromethane. Next, the resulting solid is filtered our and collected. The filtrate is then treated with a molecular sieve to remove any trace water. Any remaining dichloromethane is removed by evaporator. The resulting product is dried in a dynamic vacuum to yield a dark crystal product (0.26 grams) [SPAN-TBA salt]. Next, 0.1 grams of the SPAN-TBA salt is added to a triple flame-dried 25 mL round-bottom flask. Then, 10 mL of distilled ∈-caprolactone and 1 μL of tin (II) 2-ethylhexanoate is added to the flask. A flash reaction is conducted in the flask under nitrogen, the flask is then immersed in a 120° C. oil bath with magnetic stirring. The reaction is permitted to proceed for 48 hours. After 48 hours, the flask is permitted to cool to room temperature and the resulting product is dissolved with 20 mL of dichloromethane. The resulting solution is poured into 200 mL of methanol to precipitate the desired product and stirred overnight. The next morning, the resulting product is filtered out by Buchner funnel and dried under a dynamic vacuum for 24 hours. The product is SPAN-PCL 8.12 grams, yield is about 80 percent.

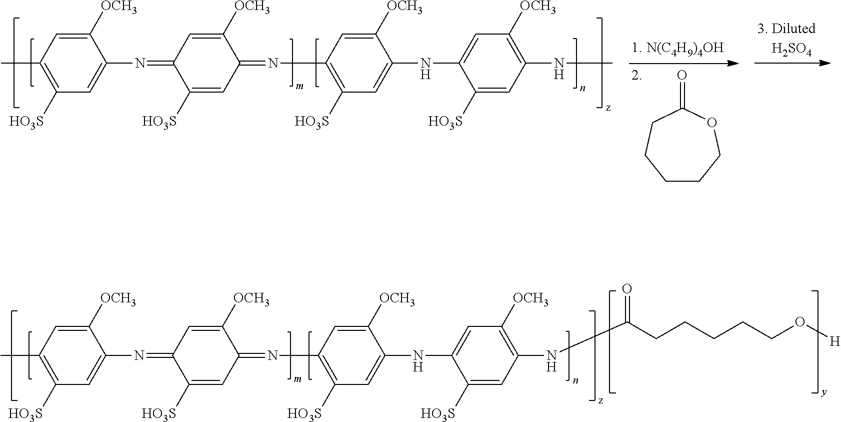

### Synthesis of Organic-Soluble Sulfonated Polyaniline Salts:

The sulfonated polyaniline (SPAN) has an unique self-doping property that makes it conduct under various pH environments. Structurally, the sulfonic groups on the aromatic rings provide the doping protons to the polyaniline chains. Because of its anionic, strong acidic sulfonic groups, SPAN is polar. It is soluble in an aqueous base, slightly soluble in polar solvents like DMF and DMSO. SPAN does not dissolve in common, less-polar organic solvents at all. Hence, it is a challenge to synthesize copolymers of SPAN with ∈-polycaprolactone in an organic phase in which polymerization of ∈-caprolactone can take place.

To determine the synthesis of SPAN-PCL, polar solvents (DMSO and DMF) have been examined in ring-opening polymerization. However, no success is had using these polar solvents. There is no polymerization reaction of caprolactone. Besides, some side reactions occurred between the reagents and DMSO and those side reactions generated hard-to-handle sulfide compounds. One strategy that can be utilized manipulate the sulfonic-containing organic molecules to dissolve in less-polar organic solvents.

This is also a challenge for organic synthesis of the sulfamide compounds which are important in pharmaceutical areas. In order to do this, organic bases like pyridine, triethylamine, and tetra-alkyl-ammonium salts are commonly used in organic synthesis of sulfonate esters. For example, the p-toluenesulfonic acid and pyridine can form a stable salt, pyridinium p-toluenesulfonate, which can dissolve in common organic solvents such as chloroform or tetrahydrofuran. In this example, SPAN is treated with an organic base to form organic soluble salts. The concept is to neutralize the proton of the sulfonate group with an organic base. As a result, the negative charge on the sulfonate group is neutralized by a positive organic base. Those resulting SPAN-organic compounds then can be dissolved in a common organic solvent such as dichloromethane.

Different organic bases including pyridine, triethylamine, dimethylamine pyridine, and tetraalkylammonium hydroxide are tested. The tetrabutylammonium hydroxide yields the best result for forming salts soluble in organic solvents. Polyaniline with different sulfonation (50 percent, 75 percent and 100 percent on the backbone) are tested with the organic base and their tetrabutylammonium salts indicate some degree of solubility in organic solvents. The best result is from the fully sulfonated polyaniline (available from Nitto Chemical) with tetrabutylammonium hydroxide.

Fully sulfonated polyaniline 0.52 grams (available from Nitto Chemical, exact molecular name: poly(2-aminobenzene sulfonic acid)) is mixed with 5 mL tetrabutylammonium hydroxide (1.0 M H₂O solution) in a 50 mL round bottom flask. The reaction mixture is heated to 95° C. in a water bath for 60 minutes. Some water forms during this process and is removed by a rotary evaporator. Then 10 mL dichloromethane is added to the flask to dissolve the product. The resulting brown solution is filtered to remove solid debris. The filtrate is treated with 10 grams of a molecular sieve with a pore size of 4 Angstroms to remove any trace water that may exist in the solution. The dichloromethane is removed by a rotary evaporator and the brown product is dried under a dynamic vacuum for 48 hours. This yields a dark crystal product (yield is about 70 percent).

### Synthesis of Sulfonated Polyaniline-Polycaprolactone Copolymer:

To synthesize the copolymer, 0.10 grams of tetrabutylammonium sulfonated polyaniline (TBA-SPAN) is added to a flame-dried 25 mL round-bottom flask. Then, 10.8 mL (100 mmoles) of freshly distilled ∈-caprolactone and 13.5 mg Sn(Oct)₂ are added to the flask. The flask is purged with nitrogen and immersed in a 120° C. oil bath with magnetic stirring. The TBA-SPAN dissolves in the ∈-caprolactone to give a deep brown solution. As the reaction proceeds, the reaction mixture becomes thick indicating the elongation of the polymer chains. After 48 hours, the flask is cooled to room temperature and 20 mL dichloromethane is added. The resulting solution is added into 200 mL of 10° C. methanol to precipitate the product under stirring for 8 hours. The solid product is collected by a Buchner funnel and washed with methanol (100 mL×3). The product is then dried under a dynamic vacuum for 24 hours.

### Synthesis of SPAN-PLA Copolymer:

SPAN (0.52 grams from Nitto Chemical) is mixed with 5 mL tetrabutylammonium hydroxide (1.0 M H₂O solution) in a 50 mL round bottom flask. The reaction mixture was heated to 95° C. in water bath for 20 minutes. Some water is formed in this process. The water in the flask is removed using a rotary evaporator. Then, 10 mL of dichloromethane is added to the flask. The resulting brown solution is filtered to remove debris. The filtrate is treated with 10 grams of a molecular sieve (pore size 5 Angstroms) to remove any trace water. The dichloromethane from the filtrate is removed by rotary evaporator. The product is then dried under dynamic vacuum to yield a dark crystal product [SPAN-TBA salt]. Next, 0.1 grams of SPAN-TBA salt is added to a triple flame-dried 25 mL round-bottom flask. Then, 3.6 grams of re-crystallized 3,6-dimethyl-1,4-dioxane-2,5-dione and 13.5 mg of tin(II) ethylhexanoate are added to flask. The reaction flask is then purged with nitrogen and immersed in 120° C. oil bath under magnetic stirring. After 48 hours, the flask is cooled to room temperature. Then, 20 mL of dichloromethane is added to the flask and the resulting solution is added into 200 mL of cool methanol under stirring and stirred for 24 hours. This product is then collected by Buchner funnel and washed with methanol (100 mL×3). The resulting product is dried under a dynamic vacuum for 24 hours.

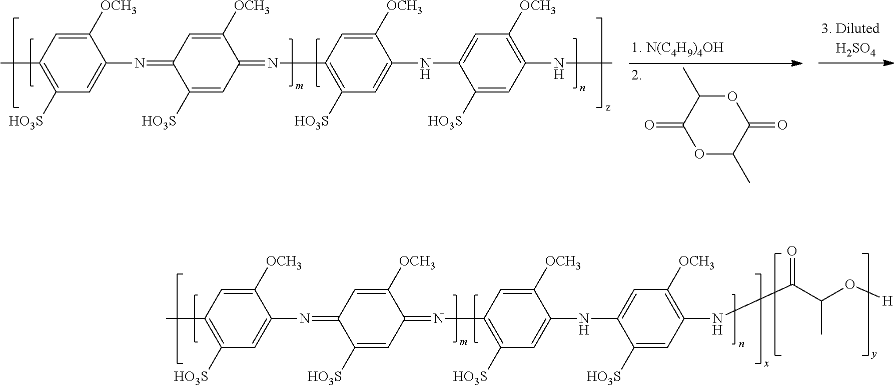

### Synthesis of the Sulfonated Polyaniline-Polylactic Acid Copolymer:

Initially, 0.125 grams of tetrabutylammonium sulfonated polyaniline (TBA-SPAN) powder is added to a flame-dried 25 mL round-bottom flask. Then, the monomer, 3,6-dimethyl-1,4-dioxane-2,5-dione (7.20 grams, 0.05 moles), and Sn(Oct)₂ (40.5 mg, 0.1 μmoles) are added to the reaction flask. The reaction flask is purged with nitrogen and immersed in a 120° C. oil bath under magnetic stirring. The TBA-SPAN is dissolved in the melted 3,6-dimethyl-1,4-dioxane-2,5-dione to yield a deep brown solution. As the reaction is proceeding, the reaction mixture becomes thick indicating elongation of the polymer chains. After 48 hours, the flask is cooled to room temperature and 20 mL of dichloromethane is added. Then, the resulting solution is added to 200 mL of 10° C. methanol under magnetic stirring for 8 hours to precipitate a solid. The solid product is collected by a Buchner funnel and washed by methanol (100 mL×3). The product is dried under a dynamic vacuum for 24 hours.

### Boronic PANI Synthesis Route:

Initially, 3-aminophenylboronic acid (0.1488 grams) is dissolved in 20 mL solution of 10M fructose and 40 mM sodium fluoride (solution A). Next, 0.5 mL of ammonium persulfate aqueous solution (40 mM) is added to solution A drop-wise under stirring for 16 hours. The resulting product is collected by the Buchner funnel and washed carefully with 10M fructose solution (20 mL×3). The product is suspended in 1 mL fructose solution.

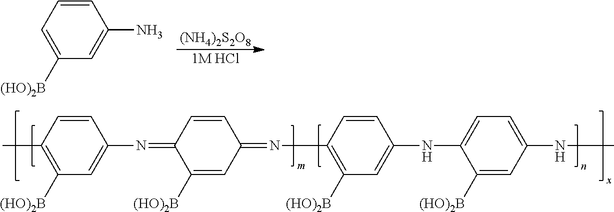

The above product can then be utilized to synthesize a copolymer.

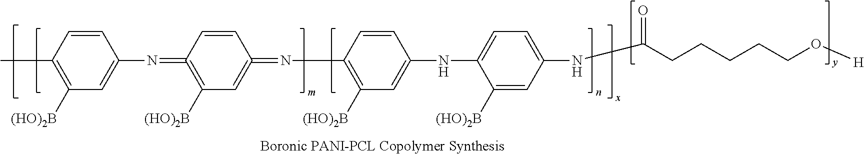

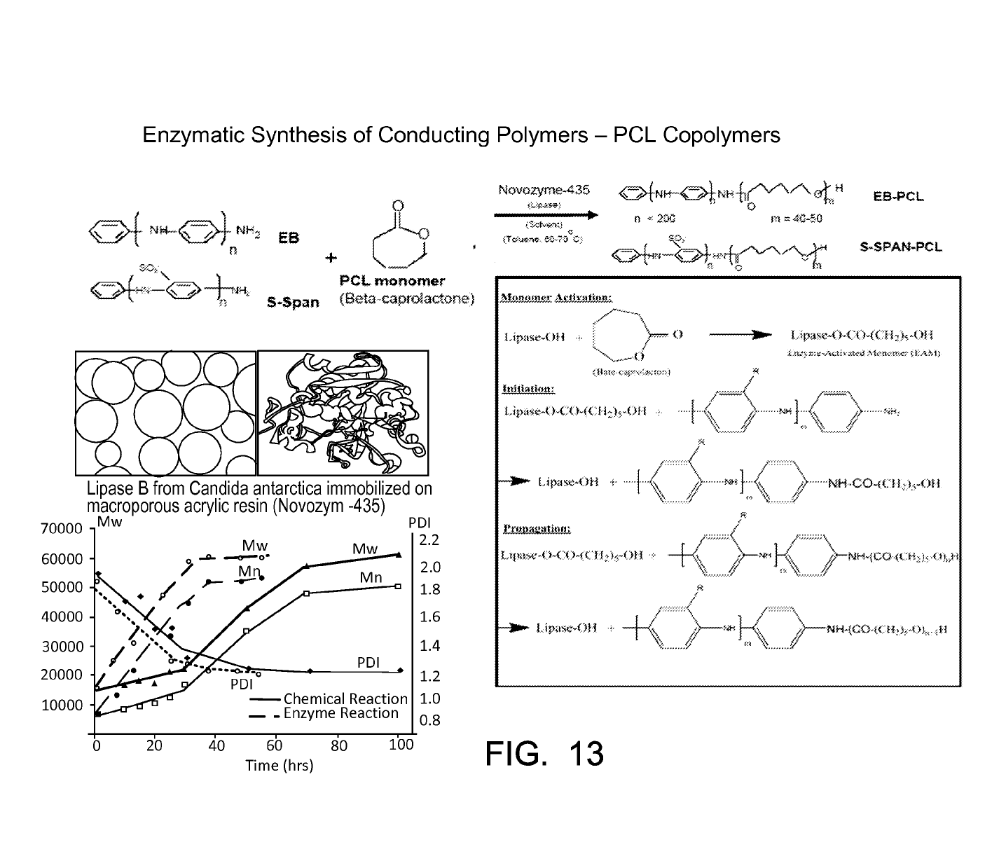

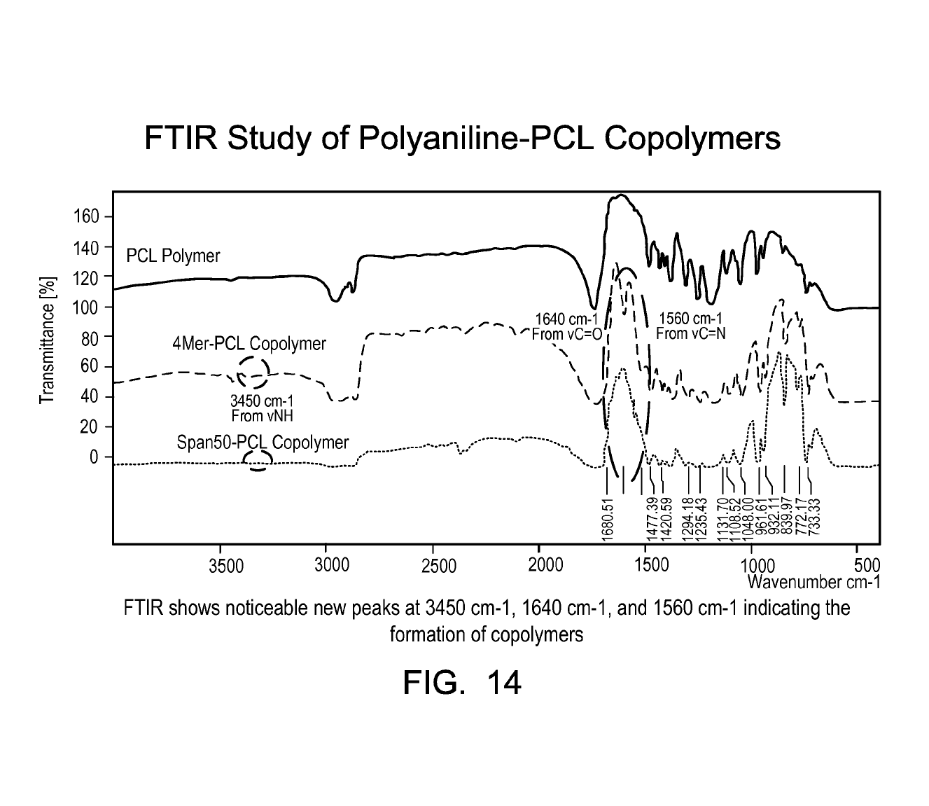

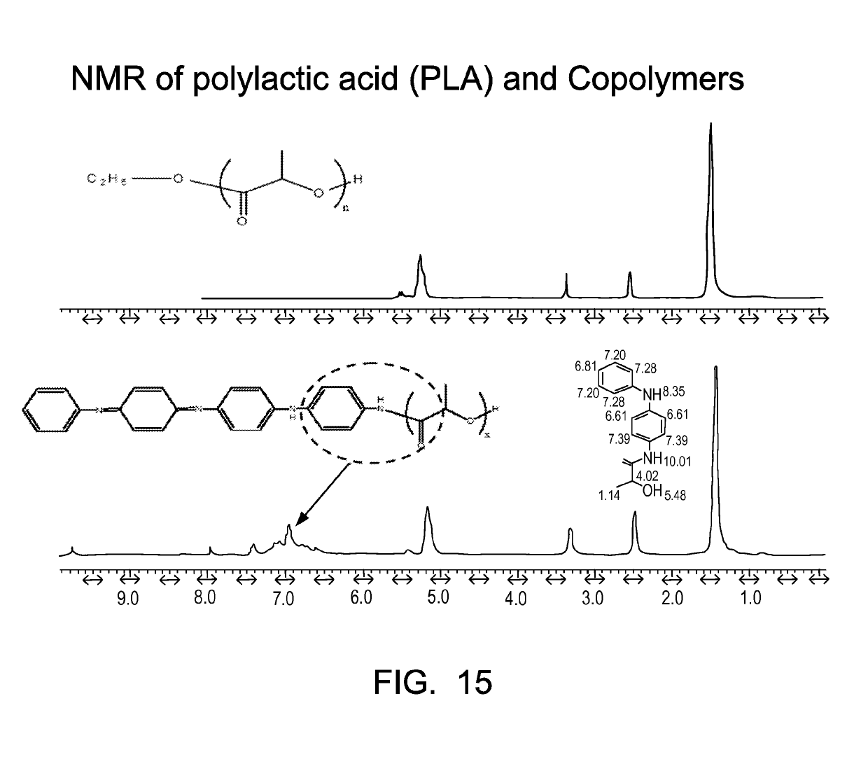

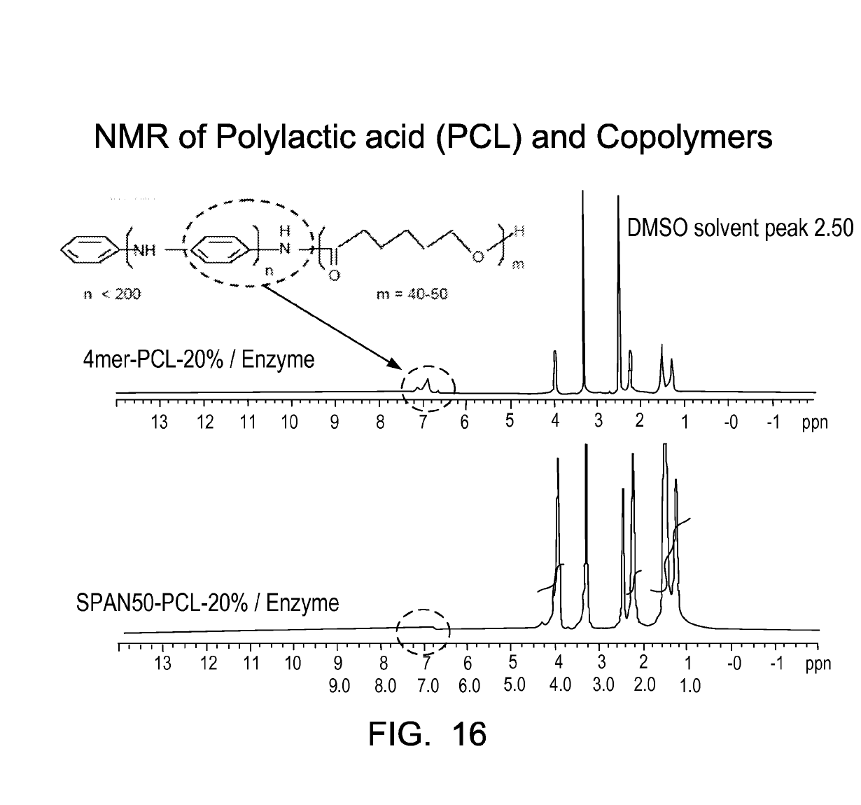

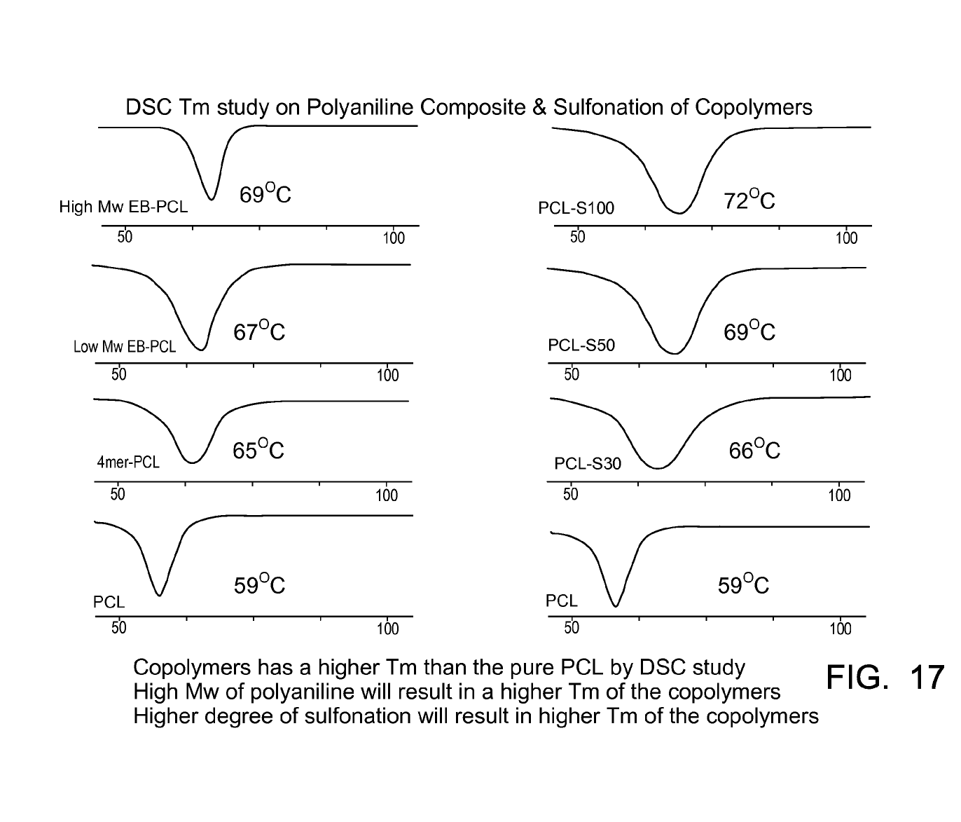

FIG. 13 details an enzymatic synthesis route for conducting polymers—PCL copolymers. FIG. 14 is a graph of various FTIR-traces of polyaniline-PCL copolymers in accordance with the present invention. FIG. 15 is an NMR of polylactic acid (PLA) and related copolymer, whereas FIG. 16 is an NMR of polycaprolaton (PCL) and related copolymer. FIG. 17 are DSC traces of various copolymers of the present invention and comparative compounds showing that the copolymers of the present invention have higher Tₘs than the pure PCL by DSC study. Additionally, high Mw polyaniline will result in a higher Tₘ of the copolymers and a higher degree of sulfonation will result in higher Tₘ in a copolymer compound.

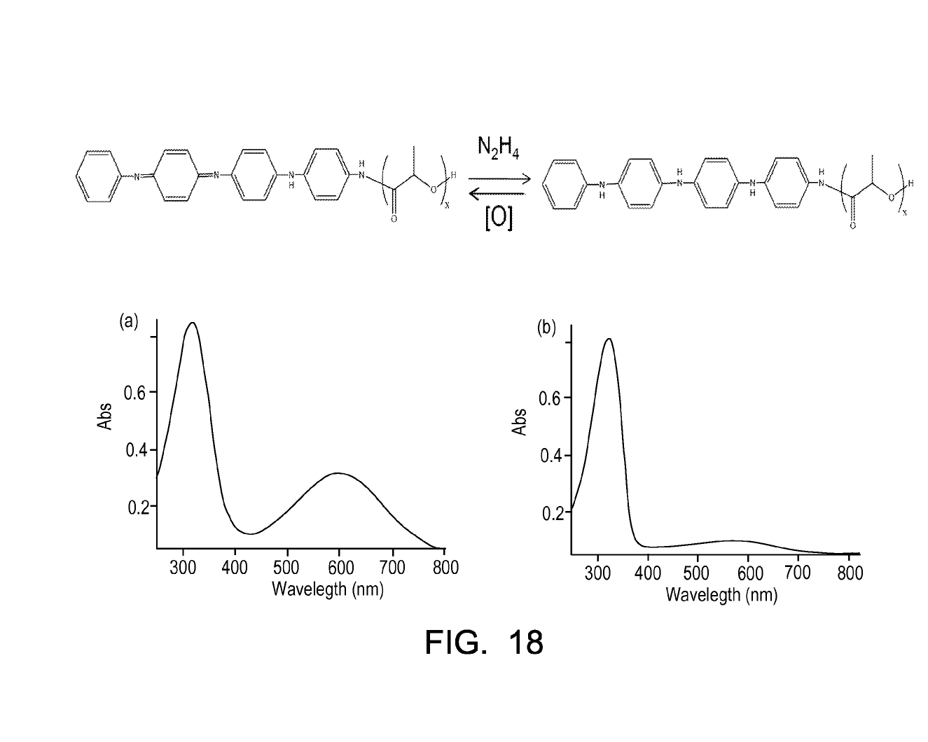

Additionally, polyaniline-polyester copolymers in accordance with the present invention are soluble in common organic solvents like anisole, are melt/solution processable, can be doped/de-doped like polyaniline, are biocompatible and biodegradable and have suitable electrical conductivities. FIG. 18 is a reaction by which doping/de-doping can occur as well as absorbance data for the two different compounds illustrating the changes associated with the doping/de-doping process.

### The Conductivity of Copolymers:

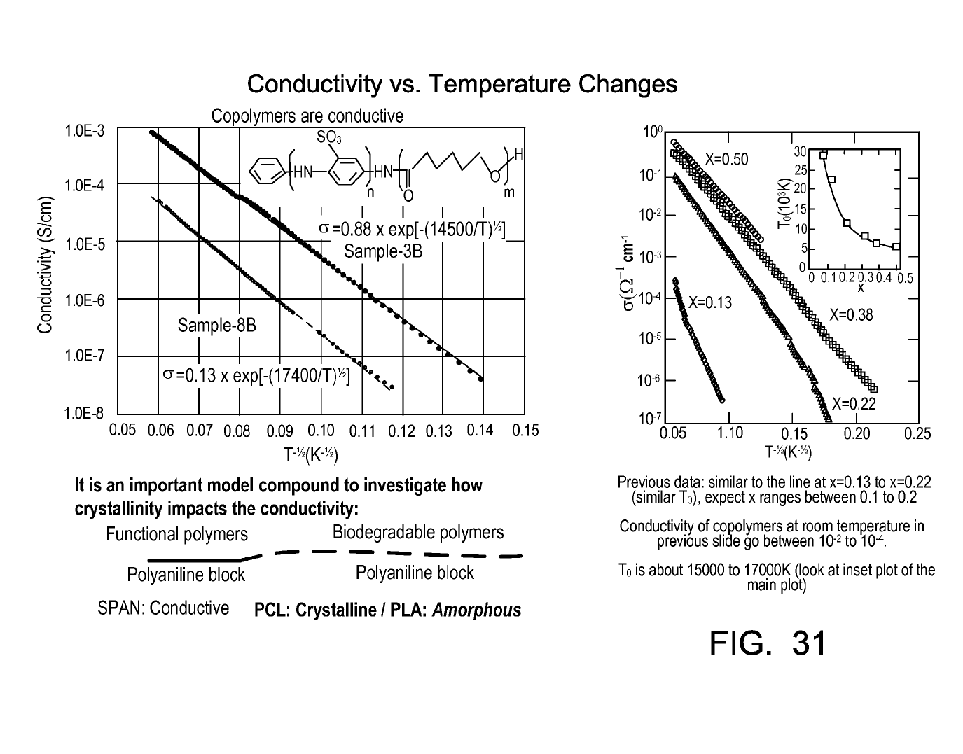

Two spun coated copolymer films are made in order to measure the copolymer conductivity versus temperature changes (see FIG. 31). Sample-3B is a copolymer of about 30 weight percent SPAN-30 with about 70 weight percent PCL and sample-8B is a copolymer of about 20 weight percent SPAN-50 with about 80 weight percent PCL. The conductivity of both film at room temperature is in the range of 10⁻² to 10⁻⁴ S/cm and their temperature dependence is similar to the pure polyaniline as published by Zuo, Angelopoulos, MacDiamid, Epstein, PRB 36 3475 (1987). Thus, copolymers of the present invention can possess high conductivity (>10-4 S/cm), which can be used as a conducting electrodes for tissue engineering studies.

### The Biocompatibility Assay:

The biocompatibility of a polymer in accordance with the present invention is tested by using human osteosarcoma cells (HOS). The attachment and growth of HOS on the substrate is an indication for toxicity. The substrates are sterilized by irradiating UV with a wavelength of 360 nm for 1 hour. Then cells taken from the cell culture flask are seeded to the substrates and the density of the cell is adjusted to 105 cells/mL. Next, the cells are cultured with substrates in a 37° C. incubator for 48 hours. Then, the substrates are moved out from the cell culture medium and incubated in the stain medium containing a 2 μM calcein AM dye and 3 μM propidium iodide for 40 minutes. Then the substrates are carefully washed with PBS and flipped over for fluorescence photographing. The fluorescence images are taken by a Nikon TS-100 fluorescence microscope with a 488 nm excitation UV light source. The live cells are stained by calcein AM dye (green fluorescence) and the dead cells are stained by propidium iodide (red fluorescence).

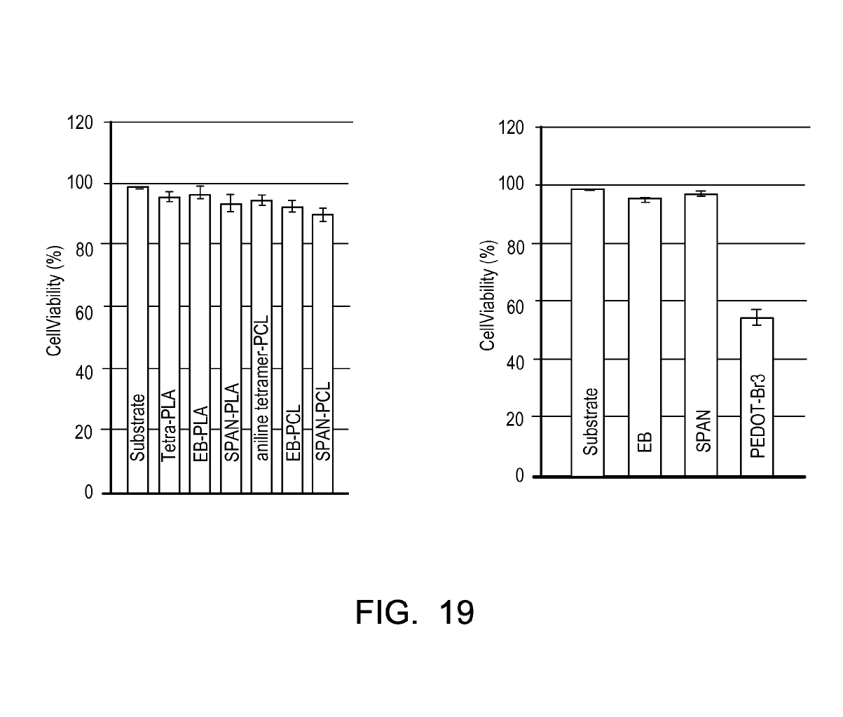

Given this, the images are studied to determine the green fluorescence, which indicates the live cells that have absorbed the green calcein AM dye and accumulated in the cytosol. Whereas the red fluorescence indicates the propidium iodide has penetrated into the nucleus of the dead cells and bound to the DNA. The dye intercalating with the DNA emits red fluorescence with a wavelength peak at 575 nm. Because the propidium iodide binds to the DNA of the nucleus, the red images have the round shape of the cell nucleus. In an image, the green and red cells are counted to determine the total cells, live cells, and dead cells. It should be noted that propidium iodide can penetrate slowly into a live cell, so the incubation time should not exceed one hour. And these two dyes are sensitive to visible light; even a slight UV light from desktop fluorescent tubes could affect the stability of the dyes. As a result, it is better to operate the staining under a dim environment. Calcein AM dye accumulated in the cells would diffuse out from the cells when the cells are immersed in PBS, so the time between the dye incubation and observation should not be longer than one hour. Given this, FIG. 19 contains a bar graph that details the amount of cells alive under the testing conditions discussed above on various substrates as noted in the graphs therein.

### Degradation Tests of Polymers:

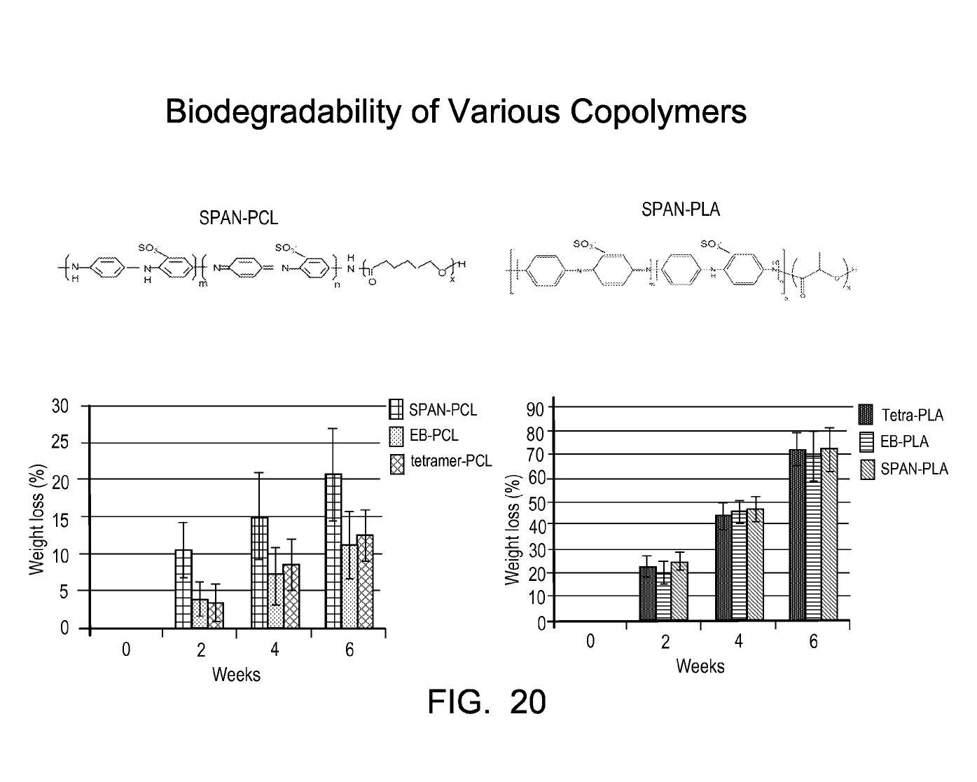

Generally, a 250 μL of polymer solution (10 percent w/v in THF) is drop-casted on a 1 inch×1 inch glass slide. Then the polymer sample is air dried at room temperature for 8 hours until the polymer samples formed dry films. Samples are peeled off from glass and dried in dynamic vacuum for 12 hours. Before incubation, the samples are sterilized by irradiating UV in biologically clean hoods for one hour on each side. This step is important because microbes like yeasts and molds could affect the results. Then the samples are immersed in a phosphate-buffered solution (pH 7.4) at 37° C. in the incubator. After a given period of time, the samples are taken out, rinsed with distilled water three times, and dried in dynamic vacuum for 48 hours. The samples are then weighed. The percentage of the weight loss is determined and calculated for the degrading rate. If there is a contaminated microbe shown on the surface of the substrates like a fungus, the samples should be discarded and marked as a failed trial. Contamination can be carefully checked by using a calcein AM dye which can uncover living microorganisms under a fluorescence microscope. Contamination is rare; however, it happens because many users share the incubators. In some instances, the contaminating organisms are fungus, yeast, and E. coli. Those microbes can eat up the polymer sample at a fast speed as they thrive in culture dishes. It can be expected that the biodegradable polymers will be degraded by living organisms in a real environment; however, those microbes have different properties, which are very difficult to control. Hence, a sterilized condition is utilized to test the baseline of degradability, which depends on hydrolysis. The results of this study are detailed in FIG. 20 which details the amount weight loss in percentages over given periods of time for the compounds noted therein.

### Additional Experimental Procedure:

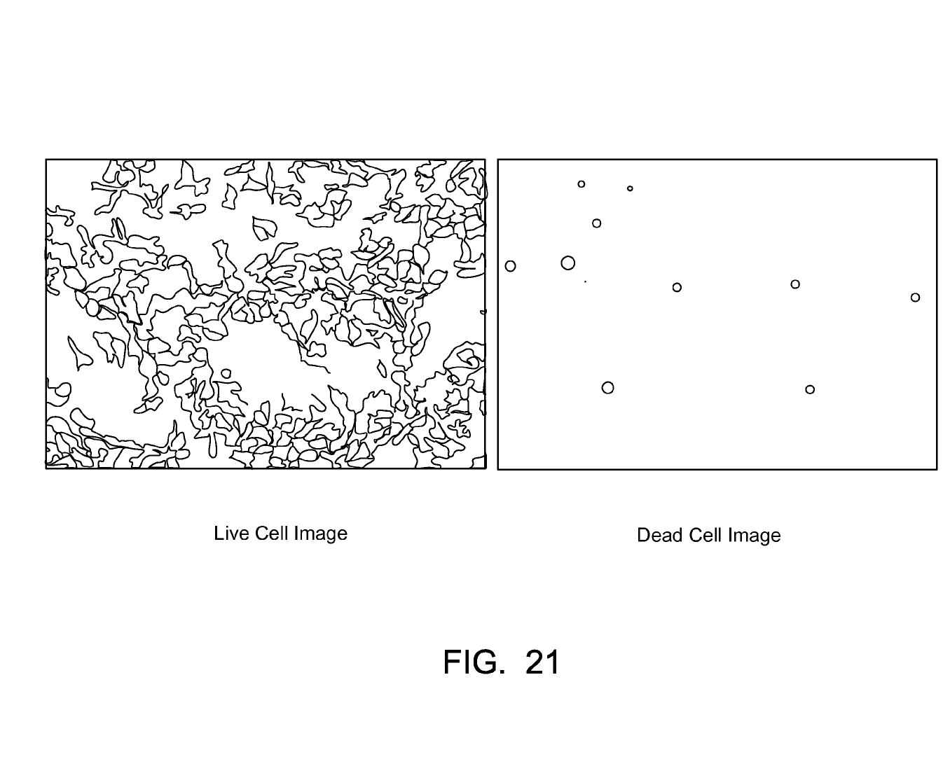

HOS cell forming monolayer in 75 cm2 cell culture flask is treated with 2 mL 1× trypsin solution (Invitrogen) in 37° C. for 5 minutes until most cells detached from the surface. Then, 3 mL cell culture medium (Eagle minimum media, ATCC with 10 percent FBS and 1 percent antibiotics/antimycin) is added to the flask to quench trypsin. The cell density is determined by hemacytometer. A good density is around about 105 cells/ml. The cell density is adjusted by adding cell culture medium. Each sample is/should be exposed to sterilizing UV light in hoods for at least 30 minutes. Porous samples should be immersed in 70 percent ethanol for 10 min for extensive sterilization. Then, the substrates are rinsed by PBS twice before testing. Cells are seeded on the top of the substrates, incubated at 37° C. (with 5 percent CO₂) for 48 hours. Cells are incubated in culture media containing 2 μM calcein AM dye and 3 μM propidium iodide for 40 minutes. Then the substrate is flipped over for the fluorescent photograph. The fluorescence images are taken by Nikon TS-100 fluorescence microscope (see FIG. 21). The live cells were stained by calcein AM dye (green fluorescence) and the dead cells were stained by propidium iodide (red fluorescence).

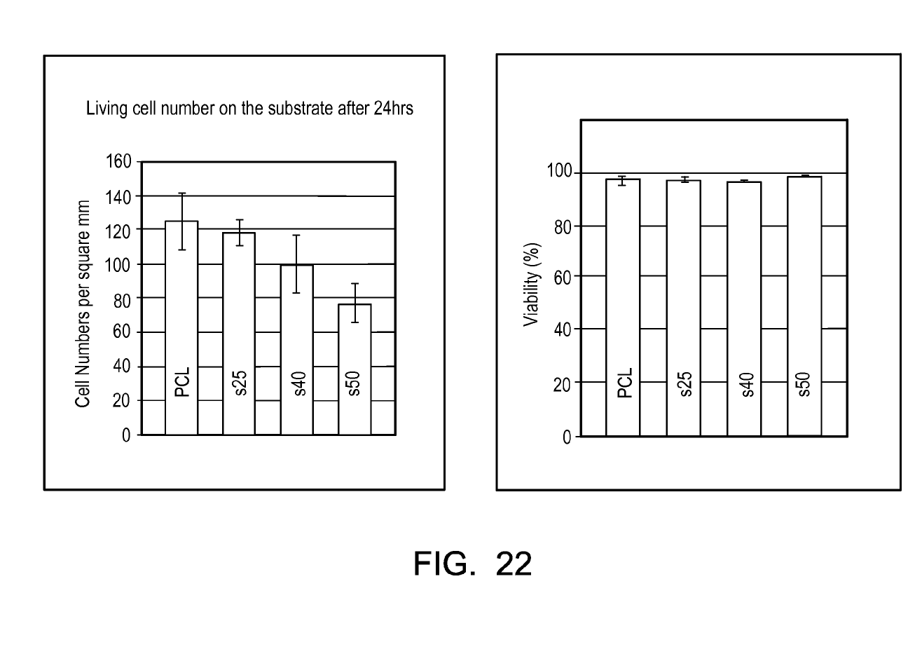

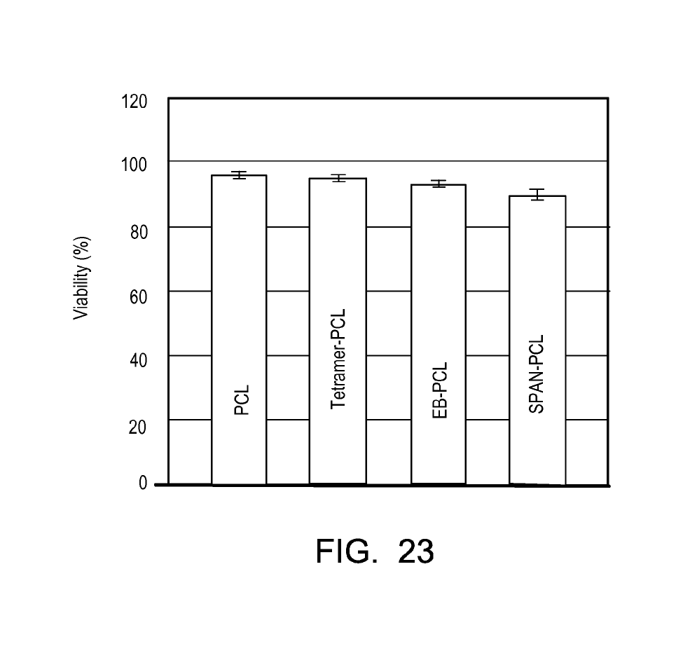

FIG. 22 illustrates various cell numbers per square mm for SPAn-25, 30, and 50 and pure PCL as a control, and the cell survival rate for SAPN25, 40, 50 versus pure PCL. The results indicated that with an increasing sulfonated percentage, cell numbers per square mm decrease about 20 percent to about 0 percent. However, the cell survival rate is almost the same. FIG. 23 is a graph detailing viabilities of cell survival rate for tetramer-PCL, EB-PCL, SPAN-PCL versus pure PCL as a control. It is found that the above copolymers have almost the same biocompatible as the pure FDA approved PCL materials.

### Cell Viability Test:

The cell viability result of various substrates, polymers, and copolymers are tested. The cell viability of PCL, aniline tetramer-PCL, polyaniline EB-PCL, and SPAN-PCL copolymers are shown in FIG. 19. The PCL is a control which has been proved by FDA as a biocompatible material. The other three copolymers have good cell viability. The polyesters and the copolymers are also been tested for their biocompatibility with cells. The polyesters are also shown to have good biocompatibility. The PEG-PCL copolymer is an interesting copolymer containing polyethylene glycol as the hydrophilic part and PCL as the hydrophobic part. PEG-PCL copolymers also have good biocompatibility.

The polyaniline EB form and the sulfonated polyaniline are also been tested for their biocompatibility. The substrates are prepared by in situ polymerization or solution-casting on glass substrates. In order to remove the residue monomers from the synthesis or the solvents used in the polymer solution, the substrates are washed thoroughly by water five times and by PBS three times. The results of the biocompatibility of the conducting polymers are shown in right hand side of FIG. 19 using a glass substrate as the control. The polyaniline EB form is the best biocompatibility; the cells showed good attachment on the surface of the substrate and have normal cell morphology. The sulfonated polyaniline is also shown to have good biocompatibility. Both the SPAN coated on the glass and that coated on the PCL substrates have similar biocompatibility.

The in situ polymerized PEDOT doped with Br3⁻ has poor biocompatibility. Actually, it showed acute toxicity for the cells. When the cells are seeded on this polymer, there are only a few cells that could attach on the surface after 24 hours. Most cells keep the round shape and could not grow. And the cells that did attach do not grow well. This is not surprising because the Br3⁻ is a toxic molecule, which is corrosive. As a result, the in situ polymerized PEDOT doped with Br3⁻ is most likely not suitable for biological applications.

### Biodegradability of Synthetic Polymers:

FIG. 20 demonstrates that the copolymer can be degraded in a similar physiological environment via hydrolysis without enzymes or microorganisms. This is a typical assay, which can demonstrate the degradability of the polymers. The experimental condition (37° C., in pH 7.4 PBS) is a mimic to the physiological situation. The weight loss along with time reflects the degradability of the material; the degradation is due to the hydrolysis of the ester bonds in the polyesters. In the test, the sulfonated polyaniline-PCL copolymer has a larger degrading rate than polyaniline EB-PCL and aniline tetramer-PCL copolymers. Possible reasons for this are that the SPAN is soluble in the slightly basic PBS, so the degraded SPAN-PCL will yield the SPAN part dissolving in the solution. On the other hand, the EB and the aniline tetramer are not soluble in an aqueous solution, so the degraded copolymers will leave the polyaniline in the solid part. This is an interesting observation, which provides important insight into this material for tissue engineering. This material can be degraded to produce soluble products. One product is caprolactone, which can enter the metabolic pathway; the other product is SPAN. The dissolved SPAN can be transported in the bloodstream to the kidneys, which filter it to excrete by the urinary system.

The other copolymers are the polylactic acid-based copolymers (PLA). These have much larger degradation rates than PCL copolymers. Intrinsically, the PLA molecule have a larger degradation rate than PCL. The copolymers based on PLA have similar faster degrading characters. Generally, the copolymers lose about 70 percent of their weight after 6 weeks, which is much faster than the PCL copolymers. PLA copolymers have similar degradation rates. Owing to the short degrading time, PLA polymers are usually applied in drug delivery.

Given the above, the present invention permits the synthesization and testing of several conducting polymers, biodegradable polymers, and their copolymers. The polyesters used here are polycaprolactone and polylactic acid, which are both approved by FDA as safe materials for biomedical use.

It has been found that copolymers based on polyaniline and polyester have good biocompatibility, which is important for the biological purpose of our project. These polyaniline-polycaprolactone and polyaniline-polylactic acid have good solubility in organic solvents like THF, which indicate better processability. The processability is important for scaffold fabrication. This is also an improvement over electrical conducting polymers because conducting polymers are known for their insolubility in common organic solvents, which limit their applications.

Biodegradability is an important property for materials used as implants. As noted above, tests are conducted to determine the biodegradability of polyaniline-PCL and polyaniline-PLA. These copolymers demonstrate degradation in PBS at 37° C. PLA-based copolymers have larger degradation rates than PCL-based copolymers. This result is consistent with the degradation rates of pure PLA and PCL. From this result, one could design and synthesize copolymers with controlled degradation rates, which would be ideal materials for implanting scaffolds.

Among these copolymers, the sulfonated polyaniline-polylactic acid copolymers have electrical conductivity. Interestingly, the PCL-based copolymers do not have electrical conductivity. The issue of reduced mechanical strength and faster degradation rate of the doped copolymers would limit their application.

### Electrospinning Embodiments:

In another embodiment, various polymers and/or copolymers of the present invention can be electrospun into various structures and/or fibers or nanofibers. Such techniques, although known in the art, will be discussed briefly below.

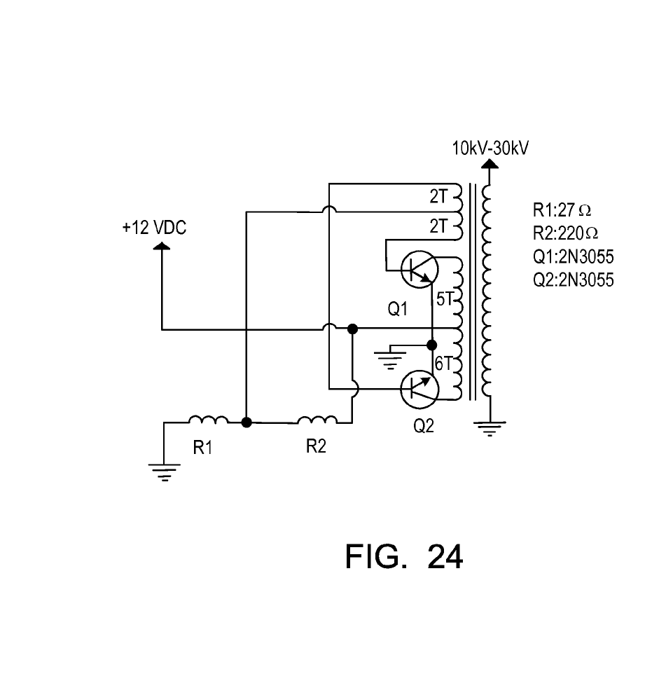

Given the above, an electrospinning technique is applied in fabricating biodegradable polymer-based fibers for tissue engineering. These polymer fibers are used as cell scaffolds which can provide structural support for cell attachment and proliferation. The polymers suitable for electrospinning include not only synthetic polymers like polycaprolactone, but also natural polymers like silk, fibrinogen, and collagen. In vitro studies have been carried out using cells like epithelium, fibroblasts, and messenchymal stem cells. In order to fabricate the fiber scaffold, one can utilize a high-voltage circuit electrospinning device as illustrated in FIG. 24.

A suitable electronic circuit is shown in FIG. 24. The principle of the circuit is based on two power transistors amplifying the oscillation of the RL circuit and increasing the voltage by the high voltage inducting coil. The voltage across the coil is increased to kilovolts by the induction coil. This induction high-voltage coil circuit is commonly used in the monitor electron beam fly-back circuit. It can also be found in many instruments like the electrospray circuit in mass spectrometer.

PCL fibers are made by electrospinning. The experimental conditions are optimized by the polymer concentration, the solvents, and the electrospinning distance between the needle to the collecting plate. The molecular weight of the polymer affects the quality of the fiber. When the molecular weight of PCL is less than 30,000 Dalton, the electrospinning product could not form fibers, but only wax-like stuff. Thus, the molecular weight of PCL is selected to be 70,000 to 80,000. The solvent used to dissolve the PCL also affects the quality of the fibers.

| | | Polymer | Fiber |
|---|---|---|---|
| Condition | Solvent | Concentration (w/w) | Forming |
| 1 | THF | 2.5% | Y |
| 2 | THF | 5% | Y |
| 3 | THF | 7.5% | Y |
| 4 | THF | 10% | Y |
| 5 | Acetone | 2.5% | Y |
| 6 | Acetone | 5% | Y |
| 7 | Acetone | 7.5% | Y |
| 8 | Acetone | 10% | Y |
| 9 | Toluene | 2.5% | N |
| 10 | Toluene | 5% | N |
| 11 | Toluene | 7.5% | N |
| 12 | Toluene | 10% | Y |
| 13 | Ethyl Acetate | 2.5% | N |
| 14 | Ethyl Acetate | 5% | N |
| 15 | Ethyl Acetate | 7.5% | N |
| 16 | Ethyl Acetate | 10% | N |
| 17 | Dichloromethane | 2.5% | Y |
| 18 | Dichloromethane | 5% | Y |
| 19 | Dichloromethane | 7.5% | Y |
| 20 | Dichloromethane | 10% | Y |

As noted above, various scaffold structures an be formed using one or more compounds in accordance with the present invention. Given this, any number of techniques can be utilized. An exemplary inventive method will be discussed below. However, the present invention is not limited thereto. Rather, any suitable technique can be utilized.

Fabricating Conducting Coaxial Fiber Scaffolds from Electrospinning:

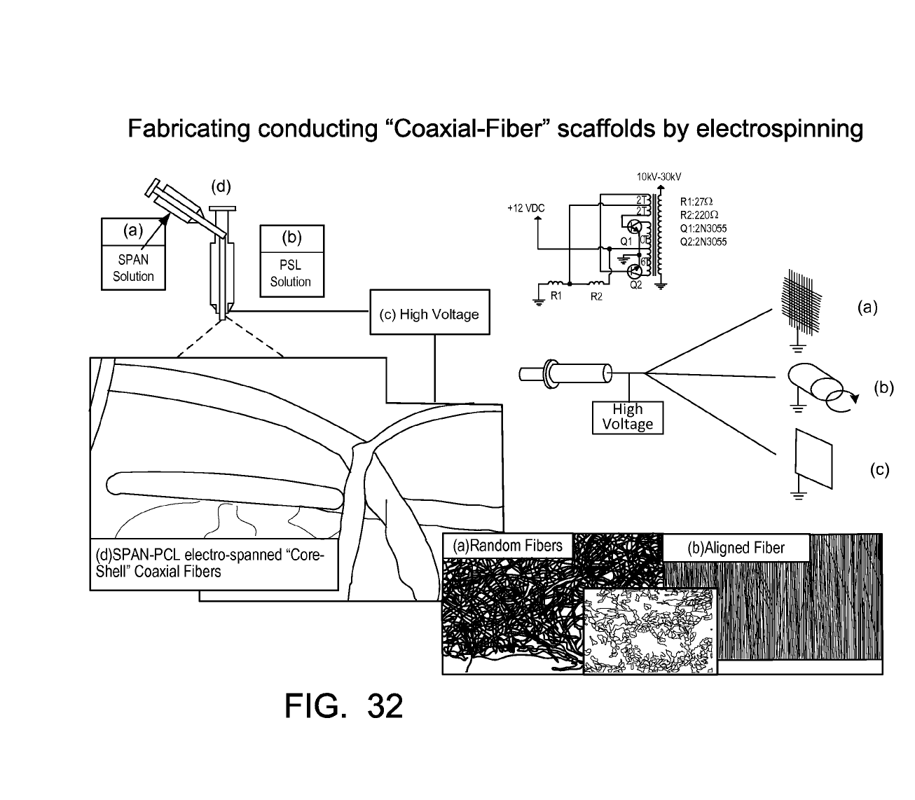

Conducting coaxial fiber scaffolds are made by the above technique, where conducting polymers and/or conducting copolymers are electrospun from the center part of the syringe (see technique (a) of FIG. 32) and biodegradable polymers were electrospun from the out core of the syringe (see technique (b) of FIG. 32). A high voltage electric is applied between the ground electrode and the coaxial syringe needles as shown in portion (c) of FIG. 32. As a result, coaxial conducting fibers are spun as shown in portion (d) of FIG. 32 and yield, for example, the structure of FIG. 32(e) which is an SEM picture. Both random coaxial fiber and aligned coaxial fibers are fabricated through the processing methods disclosed in FIG. 32. Both random coaxial fibers and aligned coaxial fibers are shown to grow HOS cells successfully under the electric fields.

Fabrication of Conducting Scaffolds Through “Multi-Steps In-Situ Polymerization and/or Multi-Layers Dipping Process:

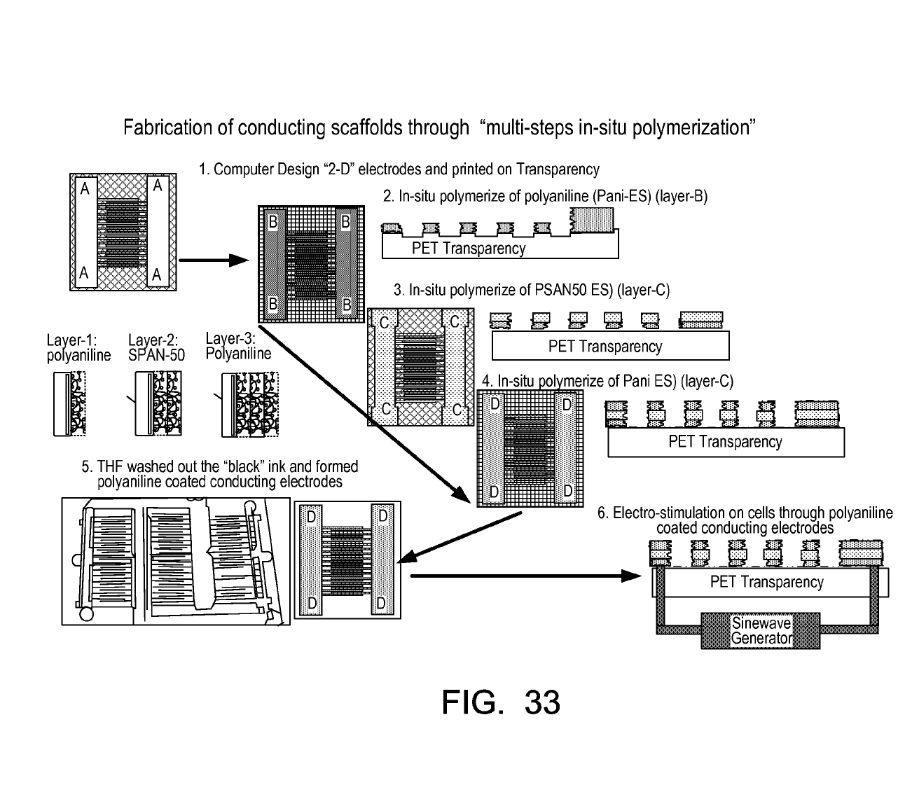

Multilayer conducting interdigited electrodes are fabricated through following processing. (1) Computer design “2-D” electrodes and printed on regular transparency or a thermal transformable substrates, which is used for transform printing for T-sheet. The thermal transform processing is used in order to transform the preprinted design into a biodegradable substrates such as, PCL, PLC or their conducting copolymers. This technique solves the major problem of how to create a print at any substrates (non-directly printable substrates). (2) In-situ polymerization of polyaniline (PANI-ES) (layer-B) on top of the printed substrate (or use dipping method to coat polyaniline layer). (3) In-situ polymerization of SPAN50 ES (layer-C) on the top of layer-B (or use dipping method to coat Span layer). (4) In-situ polymerization of PANI ES (layer-C) on top of layer-C (or use dipping method to coat polyaniline layer). (5) Using THF wash out the “black” ink and form polyaniline coated conducting electrodes. (6) Electro-stimulation on cells through polyaniline coated conducting electrodes. FIG. 33 is an illustration of the above process.

### HOS Cell Response to Electrical Stimulations:

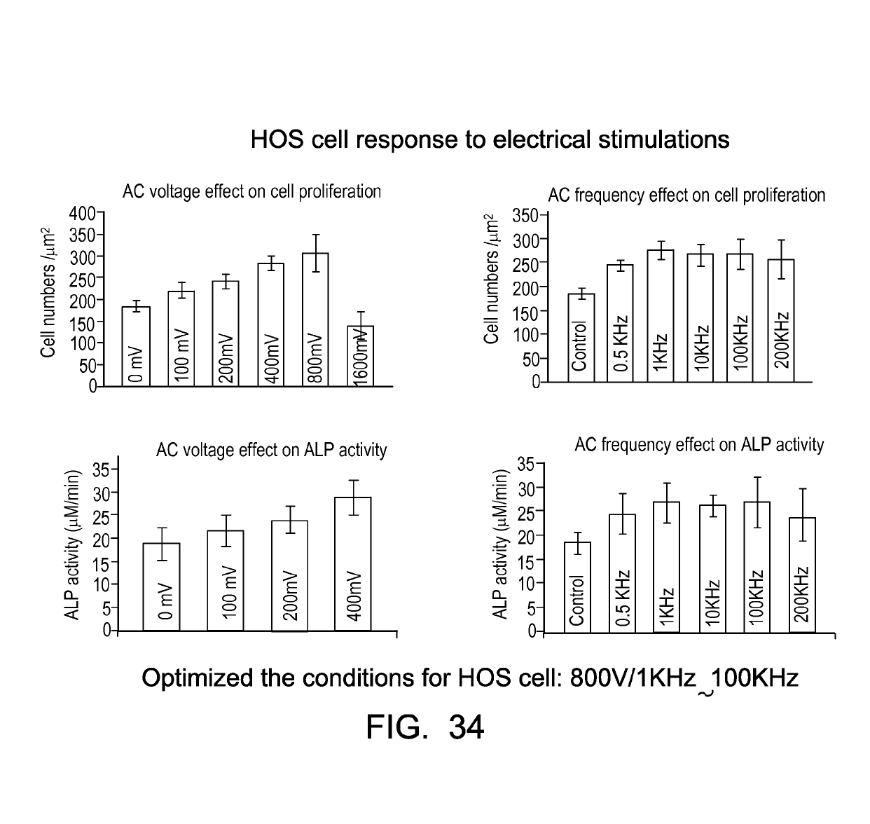

HOS cells are used to run the electric stimulation test under the electric fields. The results indicate that the electric stimulation will promote the cell growth and the optimized the conditions for HOS cell are at 800 mV electric field with frequency range of 1 KHz to 100 KHz. FIG. 34 details these results with the legends to the right-hand side of each graph corresponding from top to bottom to the bars from the left side of each graph to the right side.

### BMSC and MC3T3 Cells Response to Electrical and Stimulations:

In order to investigate on how electric and magnetic fields impact cell growth, the following experiments are conducted. Both Bone Morrow Steam Cells (BMSC) and Skeleton bone cell (MC3T3-E1) are used to run the electric and magnetic stimulation tests. The results indicate that both electric and magnetic fields will promote cell growth and the optimized the conditions for both BMSC and Mc3T3-E1 cells are at 500-1000 mV electric field with frequency range of 1 KHz to 15 KHz. The optimized magnetic filed is in the range of 20-46 gauss magnetic field.

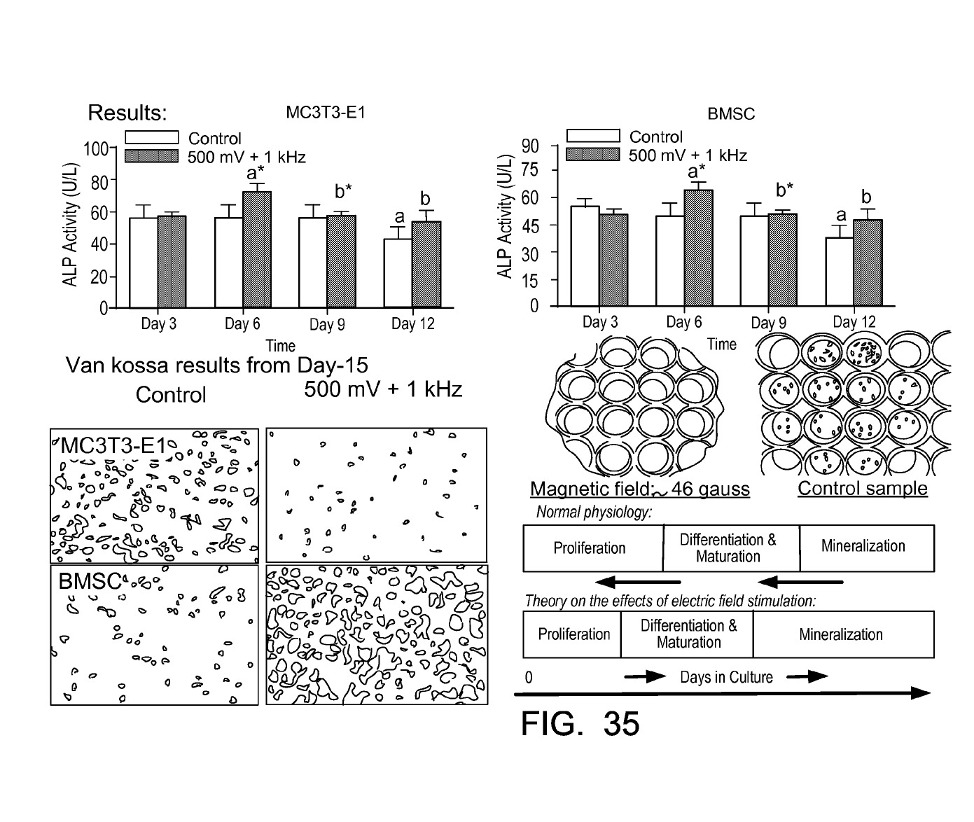

Both electric and magnetic fields will results in early maturity on cell proliferation, differentiation, and mineralization as shown in FIG. 35.

The Stamping Method:

One method for making patterns is called photolithography, which is widely used in PCB board and semiconductor fabrication. This method has been developed to generate several nanometer scales of electronic circuits in fabricating advanced circuits. Photomasks containing submicron patterns are very expensive. Besides, the dimensions of the scaffold for cell experiment is around 10-100 Km which is the dimensions of most cells.

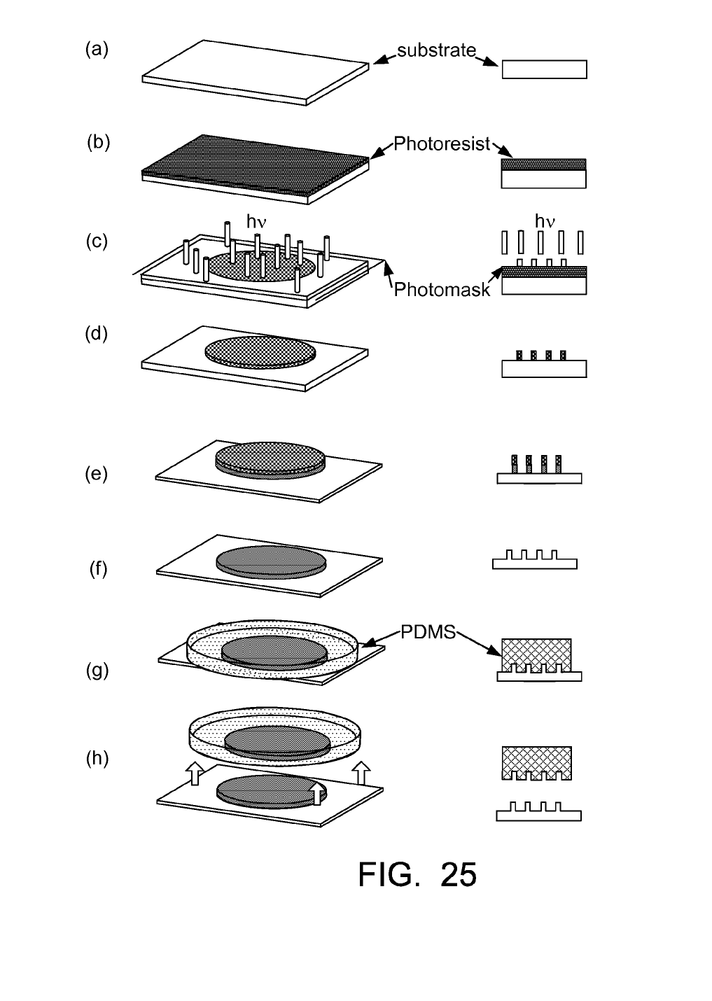

In this study, we used positive photography to make a photomask containing the pattern image. We designed and generated the pattern using Microsoft PowerPoint. We then printed the pattern on a large scale on paper (image size about 25 cm of diameter), and took the pattern's macro image (22× smaller image) on the positive film. Then we developed the film as a photomask. This macro photograph can decrease the tiny defects on the pattern. The positive film is made of nitrocellulose, which has good thermal and mechanical strength and is therefore suitable for the photomask. The procedure of fabricating the hard mold and PDMS stamp is shown in FIG. 25.

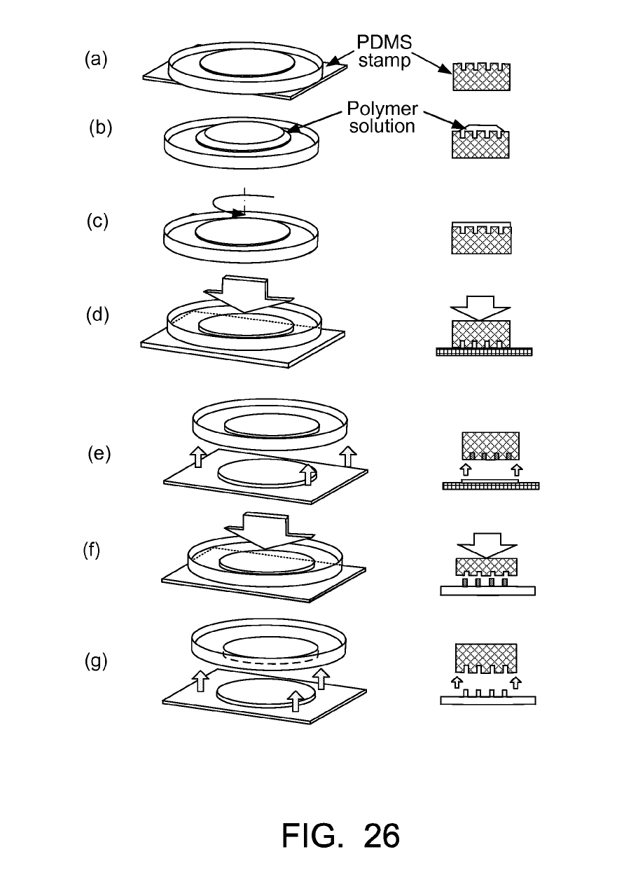

In FIG. 25 a scheme using a PDMS stamp fabrication is shown where: (a) substrate cleaning; (b) spin coating of photoresist; (c) contact exposure; (d) development; (e) etching; (f) photoresist remove; (g) PDMS curing; (h) lifting of the PDMS stamp. On the other hand, FIG. 26 illustrates a scheme of polymer scaffold fabrication where: (a) cleaning; (b) applying a polymer solution on the stamp; (c) spin coating; (d) removing the excess polymer solution; (e) lifting of the PDMS stamp; (f) transferring the polymer to a plate; (g) polymer scaffold left on glass the plate.

Once the photomask was generated, the next step was to transfer the pattern to the surface of a clean substrate such as a copper plate, glass plate, or silicon wafer in a clean room. The photoresist AZ4620 was cast evenly on the surface of the substrate by spin coating (400 rpm, 30 seconds) and baking at 110° C. for 2 minutes (FIG. 25(b)). Then the photomask was stacked on the photoresist followed by exposure to visible light (30 sec irradiation-60 sec cooling for 5 cycles). In this step, the pattern was transferred to the photoresist. Then the substrate was immersed in the developing solution (AK400, casually stirring for 1 minute) to remove the area with light exposure. After adequate developing, the pattern had a clear image as the original pattern on the photomask (FIG. 25(c)). Then the substrates were etched by chemicals. The silicon wafer and glass were etched by hydrogen fluoride, and copper was etched by ferric chloride. The copper plate was used for the hard die. Areas covered by the photoresist could not be etched. After etching, the photoresist was washed away by acetone, generating a hard die with a pattern.

The Sylgard 184 (Dow Corning) was used for making a polydimethylsilicone (PDMS) stamp. Sylgard 184 was a kit containing two agents. One agent was the silicone base and the other was the curing agent. We blended the base agent with the curing agent commonly with a 10-to-1 weight ratio, which determined the elasticity of the silicon rubber. After mixing the two agents, the liquid PDMS mixture contained many air bubbles. To remove these bubbles, the mixture was placed for 10 minutes in an exsiccator connected to a vacuum line for degassing. The degassed PDMS mixture was dispensed evenly on the hard die and then placed in vacuum for curing. The following temperatures and curing times were applied: 23° C. for 24 hours, 65° C. for 4 hours, 100° C. for 1 hour, and 150° C. for 15 minutes. The best result was derived from the curing at room temperature. When the Sylgard 184 mixture was cured completely, the stamp was pulled from the hard die and ready to use. Degassing during PDMS curing is crucial for the quality of the stamp. In spite of the degassing procedure before curing, tiny bubbles are generated and trapped on the surface of the patterning hard die, while dispensing the mixture. The trapped bubbles decrease the mechanical strength and destroy the PDMS pattern. Under vacuum, the bubbles float slowly to the surface of the liquid and explode. The scheme of procedures of a polymer scaffold is shown in FIG. 26.

The PDMS stamp was obtained from the previous steps. The PDMS stamp was covered by a polymer solution (PCL from Aldrich, MW about 80,000, 20 percent w/w in methoxybenzene) and distributed evenly by spin coating (3000 rpm for 2 minutes). The excess polymer was removed by contact of a glass plate at 62° C. for 30 seconds. This is a key step for a good scaffold because the excess polymer would block the structure of the scaffold. After removing the excess polymer, the PDMS stamp was heated to 90° C. and contacted with a glass plate at 65° C. under pressure (about 40 psi) for 3 minutes. The polymer scaffold was transferred to the plate when the PDMS stamp was lifted. Polycaprolactone scaffolds on glass substrates were detached by immersing the glass substrates in ethanol with sonication (about 3 minutes). The detached PCL scaffolds were free-standing. After air drying for 8 hours, the PCL scaffolds were ready for the cell experiments or other applications.

The Fabrication of 3D Sandwich Scaffolds:

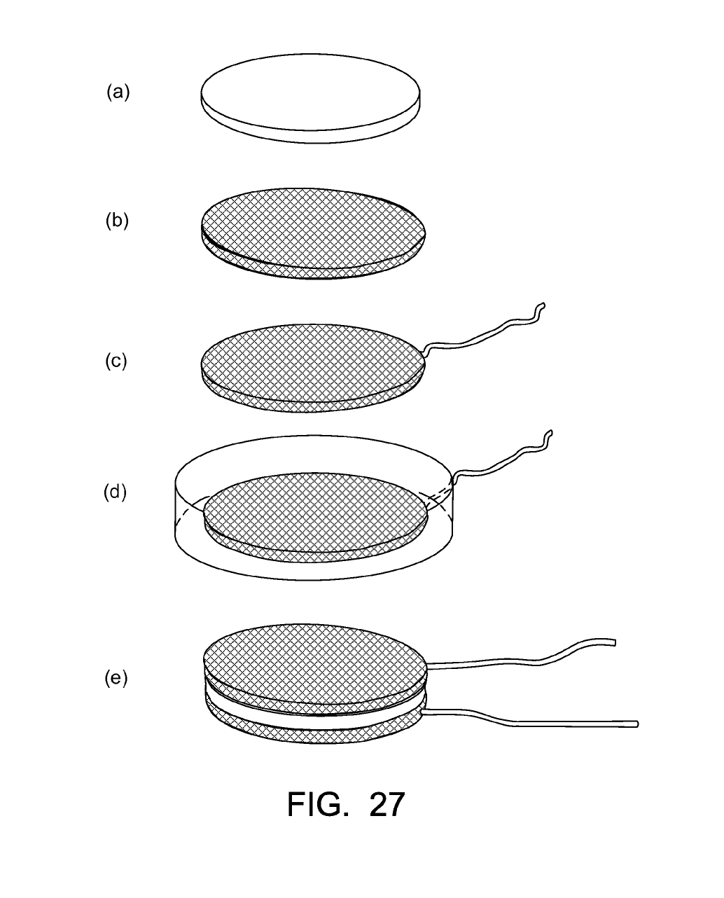

In order to construct prototype scaffolds for tissue engineering, three-dimensional electrical conductive scaffolds were designed and fabricated (FIG. 27). To allow the scaffolds to be electrically conductive, in situ polymerization of SPAN on the surface of PCL scaffolds was carried out in 1.0 M HCl solution containing 0.04 M aniline, 0.04 M 3-aminobenzene sulfonic acid, and 0.02 M ammonium persulfate at 25° C. for 24 hours (FIG. 27(b)). The SPAN coated on the scaffolds acted as an electrical conductor. This coating method provided the best result for ease of use and simple handling. After the SPAN coating on the surface of the scaffolds, we linked a copper wire to the scaffolds with silver paste. The whole scaffold was immersed in a solution of 1 percent w/w PLA/DMSO. Then the scaffold was air dried for 30 minutes. A paper tissue was used to absorb the excess DMSO. The scaffold was rinsed with water to remove DMSO thoroughly. At this stage, the scaffold was coated with a layer of PLA for insulation. The area in contact with wire needed extra painting of PLA due to the irregular shape.

FIG. 27 illustrates a scheme of a 3D sandwich scaffold fabrication where: (a) a single PCL scaffold; (b) in situ polymerization of SPAN; (c) linking of the wire; (d) immersion in a dilute PLA solution; (e) assembly of the sandwich scaffold.

Next, the wired scaffolds were assembled as a sandwich scaffold containing two conductive layers with one insulating layer spacing (FIG. 27(a)). The first method was the hot-melting technique using a variable-temperature solder tip. The temperature was adjusted to 70° C., which is above the melting point of PCL. Then the PCL scaffolds were assembled by melting a small amount of PCL on the solder tip and dispensing the melted PCL on the side of the scaffolds. When the melted PCL cooled and froze at room temperature, the scaffolds were assembled. This method is as easy and simple as soldering an electronic circuit. However, the drawback of this method is that hot tips can destroy the structure of the pattern by melting the scaffold due to overheating. Since it is difficult to make an even and precise distribution of PCL around the scaffold, there are many irregular areas which make sterilization difficult.

The second approach is to use an agarose solution as the adherent. The advantage of agarose is that it can melt at 50° C. and freeze as a gel at room temperature and 37° C. The strength of the gel can be adjusted by the concentration of agarose. The 25 percent agarose solution forms strong dense gels, so we used this concentration. The agarose solution was heated at 100° C. and kept in a 55° C. water bath. A 10 KL micropipette (Fisher) with a pre-warmed 60° C. tip was used to take the agarose solution and to dispense it quickly in the gap between the scaffolds. Sometimes the agarose solution can freeze inside the tips so the operation should be carried out quickly. The dispensed agarose solution soon formed a firm gel on the side of the scaffolds. This method is easy and the 3D sandwich has a better success rate. Besides, agarose is a biodegradable polymer which has good biocompatibility and biodegradability. These properties make agarose suitable for tissue engineering applications. A disadvantage of agarose is that it can degrade in a physiological condition within several weeks. Compared to the PCL scaffolds which have a degradation rate of two years, agarose would degrade first and lead to disassembling of the 3D sandwich. If the 3D sandwich will be used in vivo, this could be a serious issue.

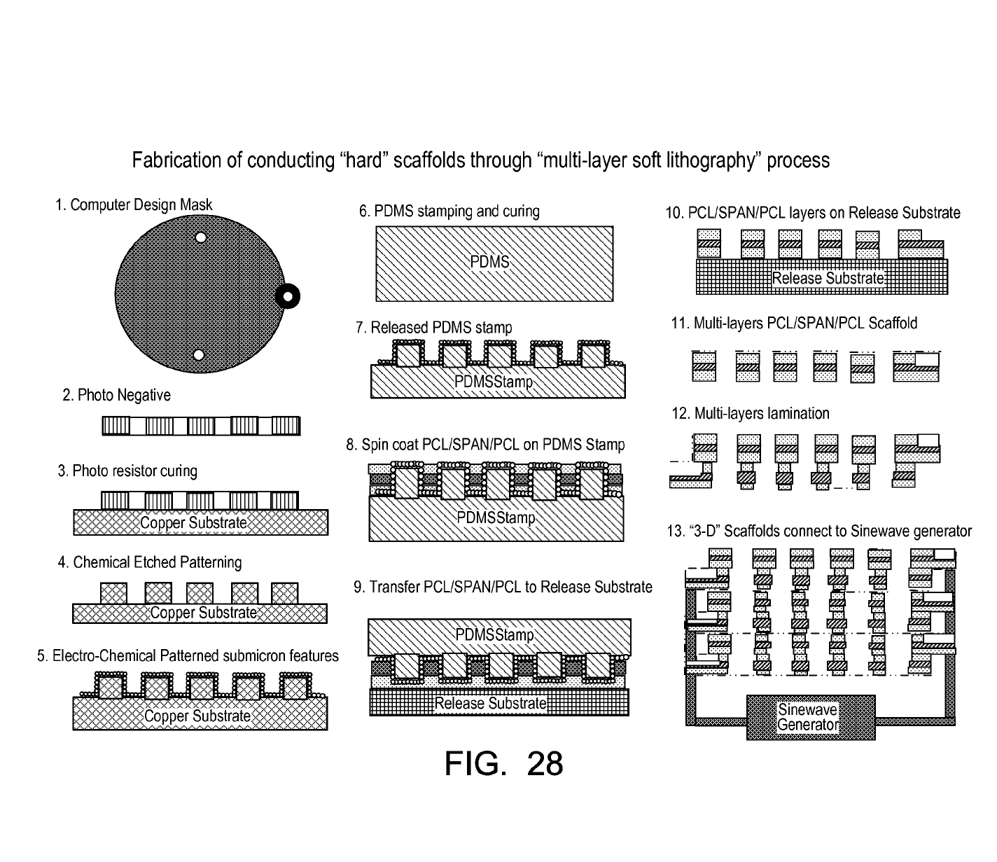

The third method is to use polyacrylamide as the adherent. Polyacrylamide has been commonly used for protein gel electrophoresis. The strength of the gel can be adjusted by the monomer concentration. In this study 30 percent monomer solution provided good strength for the scaffold. Polymerization was initiated by adding 0.1 percent ammonium persulfate to the monomer solution and the polymerization reaction was completed in one hour. The result of scaffold assembling was rinsed thoroughly with water to remove any residue monomers. FIG. 28 details one suitable method for producing conducting hard scaffolds from one or more compositions of the present invention using soft lithography techniques.

The Fabrication of Electrodes:

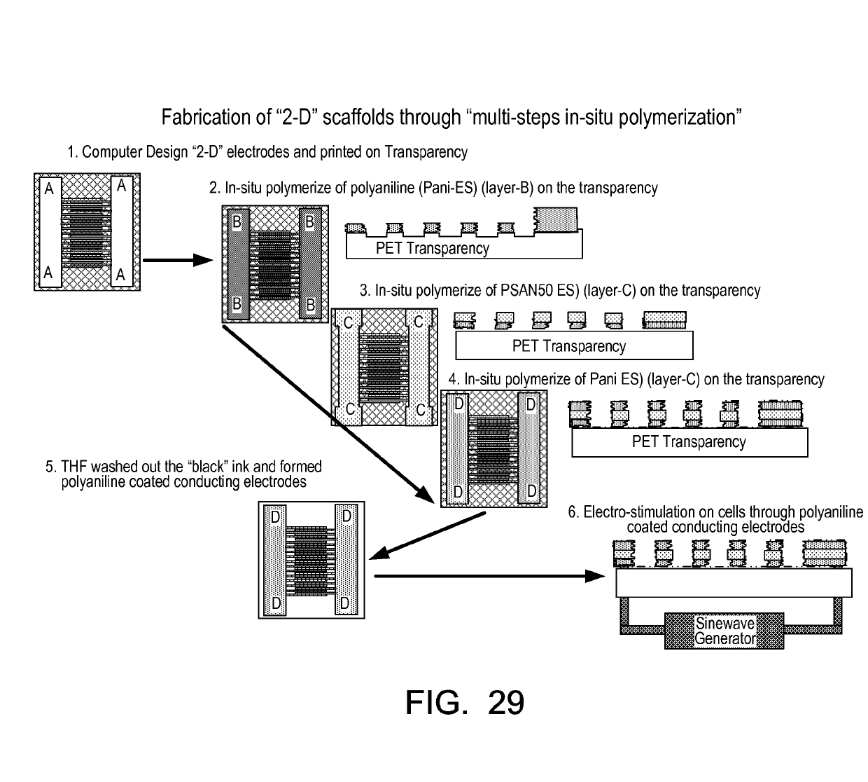

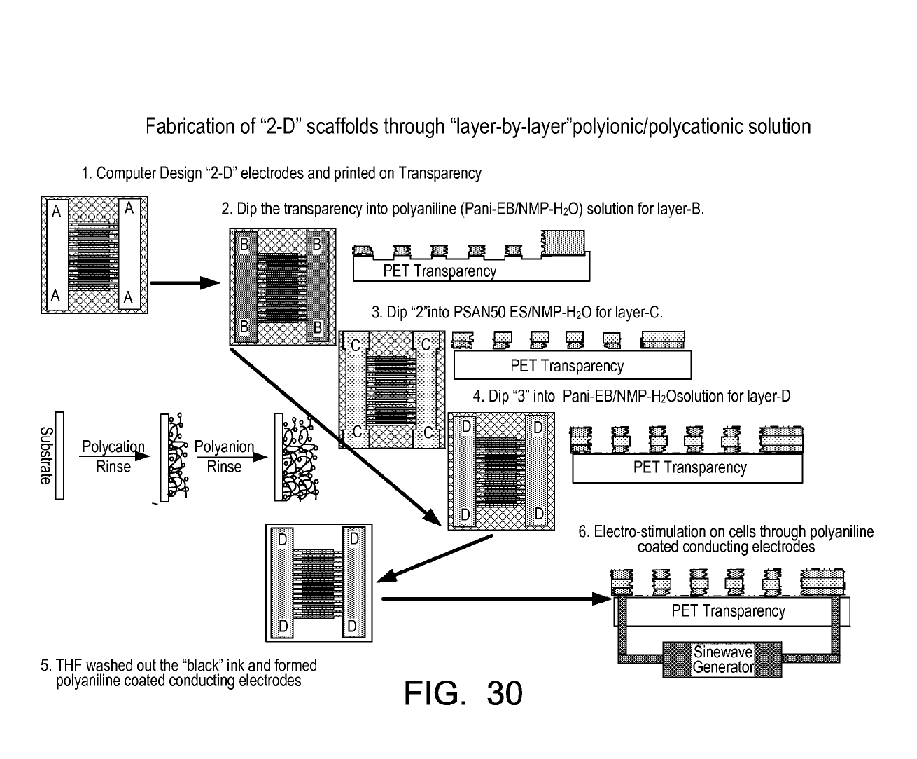

FIGS. 29 and 30 detail methods for the fabrication of electrodes. The pattern of the electrode is around several hundred Km so we chose a method to fabricate the conducting polymer-based electrodes. We printed the patterns of the electrodes (created by Microsoft PowerPoint or AutoCad) on the transparency. Then we coated the conducting polymer on the surface by in situ polymerization in a solution containing 0.04 M aniline, 0.04 M 3-aminobenzene sulfonic acid, and 0.02 M ammonium persulfate in 1M HCl aqueous solution at 25° C. for 24 hours. After the in situ polymerization was completed, the transparencies were washed thoroughly with water and PBS, followed by removing the printer toner and assembling the electrodes in a culture dish. The entire electrode dish was irradiated by UV (wavelength about 360 nm) in a biologically sterile hood for at least 1 hour. The inside of the dish was rinsed by PBS before loading the cells and the medium.

The multilayer electrodes were produced followed similar processing as described in the above. Normally, we in situ polymerized pure polyaniline as the first layer, i.e., bottom layer. Then, in situ polymerized sulfonated polyaniline as the second layer, i.e., meddle layer. Then, in situ polymerized the third layer, i.e., top layer. The total conductivity significantly increased by 10× to 100×. In addition, the conductivity at pH=7. undergos almost no change. This is because the sulfonated polyaniline middle layer had placed a role of dopant, which will supply protonation to dope the top and bottom layers of polyaniline. Five, seven, and even twenty-one layers of those multilayer electrodes were also fabricated with a conductivity of 3 S/Cm and surface resistivity of 150 ohm/squire. Those multilayer electrodes also can fabricated through multilayer dipping methods as indicated in the following. By using this method, we can use the copolymer of Span-PCL, or SPAN-PLA.

### Fabrication of “3-D” Conducting Scaffolds Through Multi-Layers Coextrusion, Co-Injection Molding and Multilayer Micro-Foaming Process:

As is discussed above, there are several processing methods to prepare conducting scaffold for electric stimulation of cell growth such as, coaxial conducting fibers, soft-lithography, etc. However, both methods may be difficult to turn into mass production methods at desired industry output rates. In such cases, other methods such as, but not limited to, extrusion, injection molding, and micro-foaming can be utilized. Thus, a co-injection molding process to make a conducting scaffold can be accomplished using a conductive material such as, conductive polymer and/or conductive copolymers that can be injected as the inner part and a biodegradable insulating polymer such as PCL PLA that can be injected as outer layers to prevent the leakage of electric current during an electric stimulation test on a cell medium.

Similarly, a co-extrusion process to fabricate a conducting scaffold can be conducted by using a conductive material such as, conductive polymer and/or conductive copolymers can be extruded as the inner part and a biodegradable insulating polymer such as PCL PLA can be co-extruded as outer layers to prevent leakage of electric current during an electric stimulation test on a cell medium.

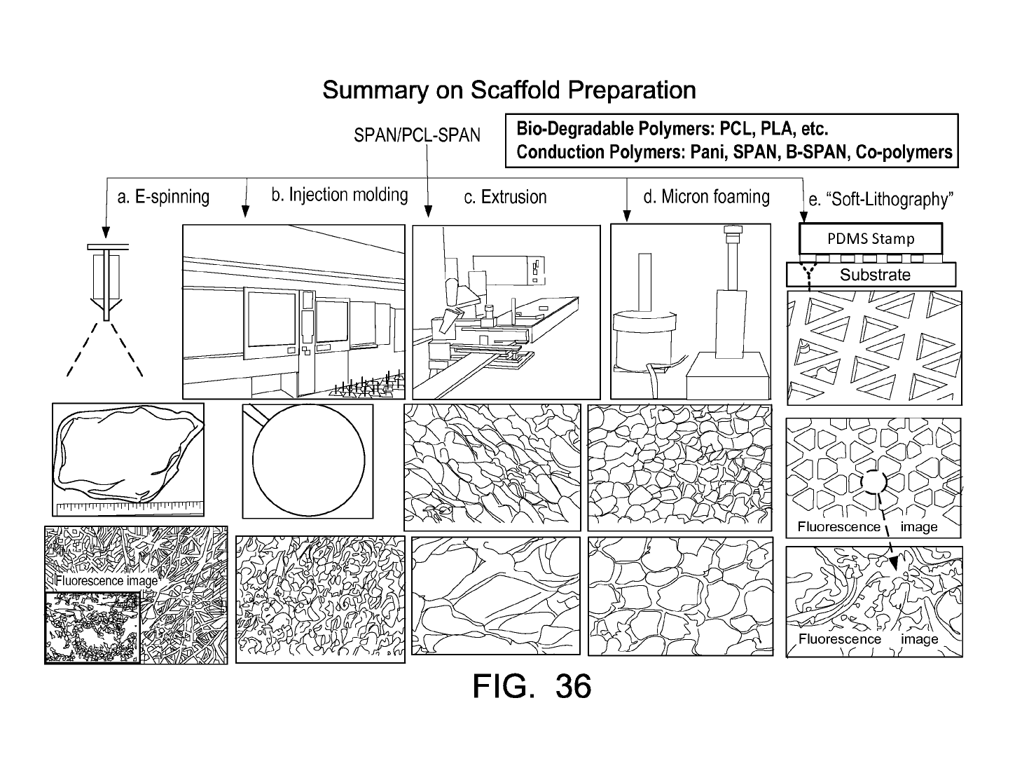

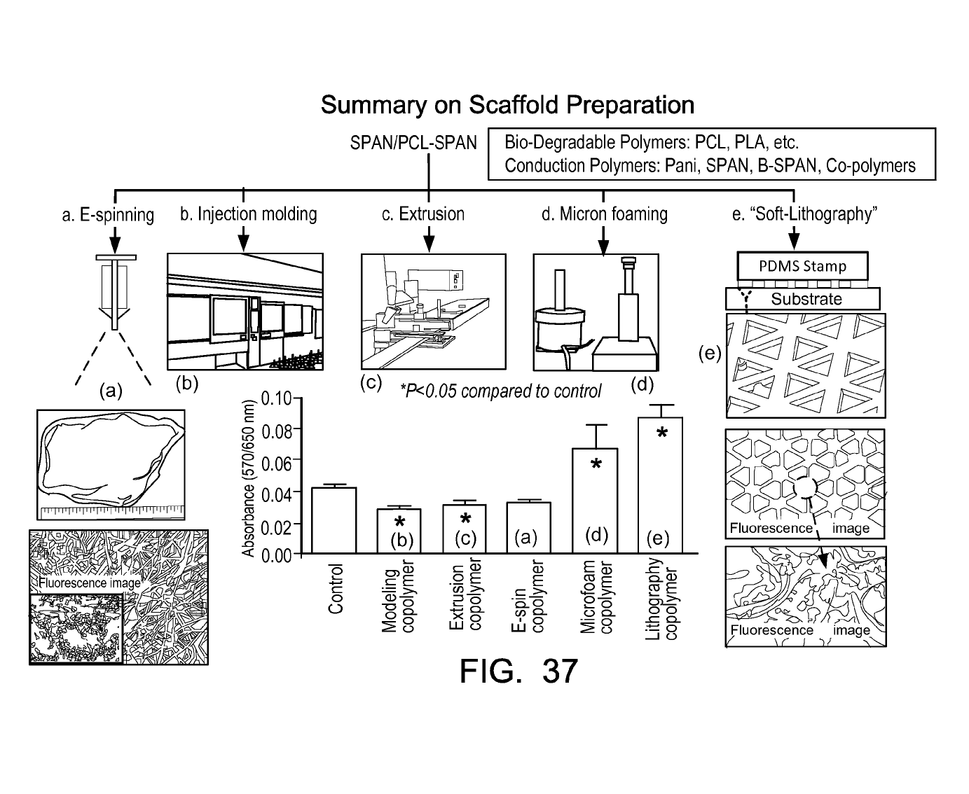

A co-micro-foaming process can also be utilized to fabricate conducting scaffolds. The multilayer laminate are produced through multilayer lamination process where a conductive material layer such as, conductive polymers, biodegradable conductive copolymers and biodegradable insulating polymers such as PCL PLA are utilized to form alternating layers of a laminate. Then, co-micro-foaming process are conducted at high pressure in a chamber using supercritical CO₂ foaming processing under a CO₂ pressure of about 2,000 psi at temperature of 50° C. for 24 hours. A quick CO₂ air releasing within 5 seconds will result the formation of micro-foaming. FIGS. 36 and 37 detail such processes.

Cell Growth Under Different Scaffolds:

Again, FIGS. 36 and 37 indicate that the cell growth will be favorable on scaffolds prepared from soft-lithography and micro-foaming processes. The other processes (labeled a, b and c are not efficient enough). While not wishing to be bound to any one theory, this could be due to a variation in scaffold porosity, i.e., it is believed that higher scaffold porosity will result in a better cell growth.

Although the invention has been described with reference to certain embodiments detailed herein, other embodiments can achieve the same or similar results. Variations and modifications of the invention will be obvious to those skilled in the art and the invention is intended to cover all such modifications and equivalents.

1. A self-doped polymer, or copolymer, composition according to Formulas (I), (II) and/or (III): 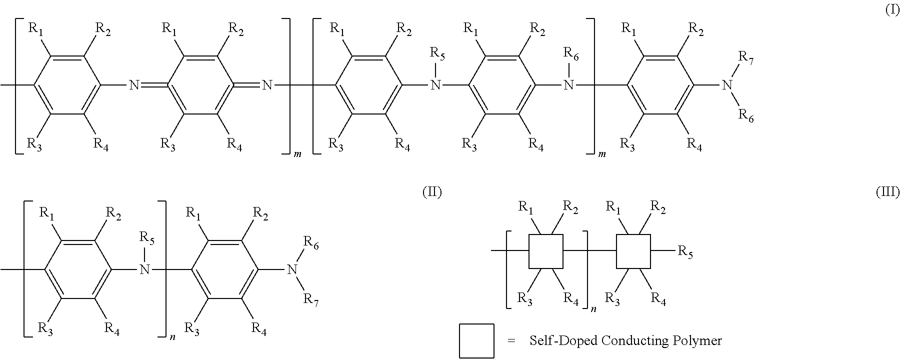
wherein m and n are independently integers selected from 2 to about 10,000, Ri, R2, R3, R4, R5, R6, R7 and R8 are independently selected from H, —SO3M, —R9SO3M, —OCH3, —CH3, —C2H5, —F, —Cl, —Br, —I, —N(R9)2, —NHCOR9, —OH, —O<″>, —SR9, —OR9, —OCOR9, —NO2, —COON, —COOR9, —COR9, —CHO, —CN, —SO3H, —B(OH)2, —SO3<″> or B(R10)2, wherein R9 is a C1 to C8 alkyl, aryl or aralkyl group, R10 is a H, a C1 to C8 alkyl, aryl or aralkyl group, C1 to C8 straight or branched alkyl, a C1 to C8 alkyl, aryl or aralkyl group that contains one or more heteroatoms selected from N, S or O, and wherein M is a H or an unsubstituted or substituted ammonia of the formula NAiA2A3 and Ai, A2 and A3 are independently selected from H and C1 to C8 straight or branched alkyl.

2. The self-doped polymer, or copolymer, composition according to claim 1, wherein any of Formulas (I) through (III) are combined with at least one biodegradable monomer to form a biodegradable electrically conductive copolymer composition

3. The self-doped polymer, or copolymer, composition according to claim 1, wherein m and n are independently integers selected from about 5 to about 5,000.

4. The self-doped polymer, or copolymer, composition according to claim 1, wherein m and n are independently integers selected from about 7 to about 2,500.

5. The self-doped polymer, or copolymer, composition according to claim 1, wherein m and n are independently integers selected from about 10 to about 1,000.

6. The self-doped polymer, or copolymer, composition according to claim 1, wherein m and n are independently integers selected from about 15 to about 500.

7. The self-doped polymer, or copolymer, composition according to claim 1, wherein m and n are independently integers selected from about 25 to about 250.

8. The self-doped polymer composition according to claim 1, wherein have a molecular weight in the range of about 500 grams per mole to about 10,000 grams per mole.

9. The self-doped polymer composition according to claim 1, wherein have a molecular weight in the range of about 750 grams per mole to about 9,000 grams per mole.

10. The self-doped polymer composition according to claim 1, wherein have a molecular weight in the range of about 1,000 grams per mole to about 8,000 grams per mole.

11. The self-doped polymer composition according to claim 1, wherein have a molecular weight in the range of about 1,250 grams per mole to about 7,500 grams per mole.

12. The self-doped polymer composition according to claim 1, wherein have a molecular weight in the range of about 1,500 grams per mole to about 6,000 grams per mole.

13. The self-doped polymer composition according to claim 1, wherein have a molecular weight in the range of about 2,000 grams per mole to about 5,000 grams per mole.

14. The self-doped polymer composition according to claim 1, wherein have a molecular weight in the range of about 2,500 grams per mole to about 4,000 grams per mole.

15. The self-doped polymer composition according to claim 1, wherein have a molecular weight in the range of about 3,000 grams per mole to about 3,500 grams per mole.

16. The self-doped polymer composition according to claim 1, wherein have a molecular weight in the range of about 500 grams per mole to about 20,000 grams per mole.

17. The self-doped copolymer composition according to claim 1, wherein have a molecular weight in the range of about 5,000 grams per mole to about 70,000 grams per mole.

18. The self-doped copolymer composition according to claim 1, wherein have a molecular weight in the range of about 7,500 grams per mole to about 60,000 grams per mole.

19. The self-doped copolymer composition according to claim 1, wherein have a molecular weight in the range of about 10,000 grams per mole to about 50,000 grams per mole.

20. The self-doped copolymer composition according to claim 1, wherein have a molecular weight in the range of about 12,500 grams per mole to about 45,000 grams per mole.

21. The self-doped copolymer composition according to claim 1, wherein have a molecular weight in the range of about 15,000 grams per mole to about 40,000 grams per mole.

22. The self-doped copolymer composition according to claim 1, wherein have a molecular weight in the range of about 17,500 grams per mole to about 35,000 grams per mole.

23. The self-doped copolymer composition according to claim 1, wherein have a molecular weight in the range of about 20,000 grams per mole to about 30,000 grams per mole.

24. The self-doped copolymer composition according to claim 1, wherein have a molecular weight in the range of about 22,500 grams per mole to about 27,500 grams per mole.

25. The self-doped polymer, or copolymer, composition according to claim 1, wherein the compound is selected from one or more of the following compounds:

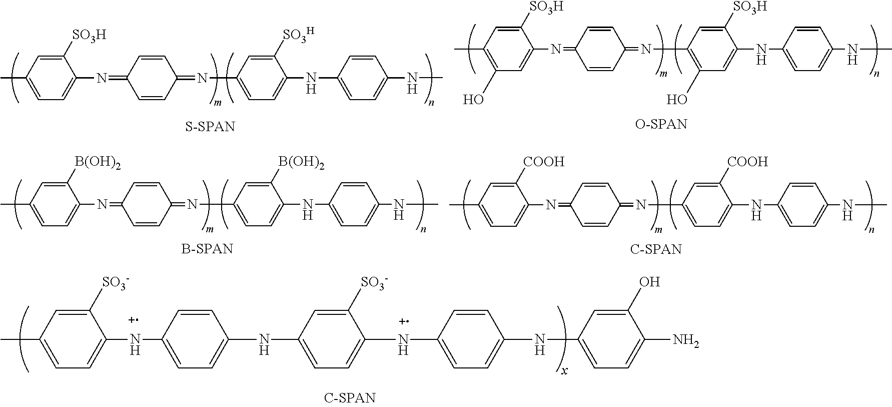

26. The self-doped copolymer composition according to claim 1, wherein the copolymer composition contains a repeating unit and/or monomer derived from one or more of the following compounds:

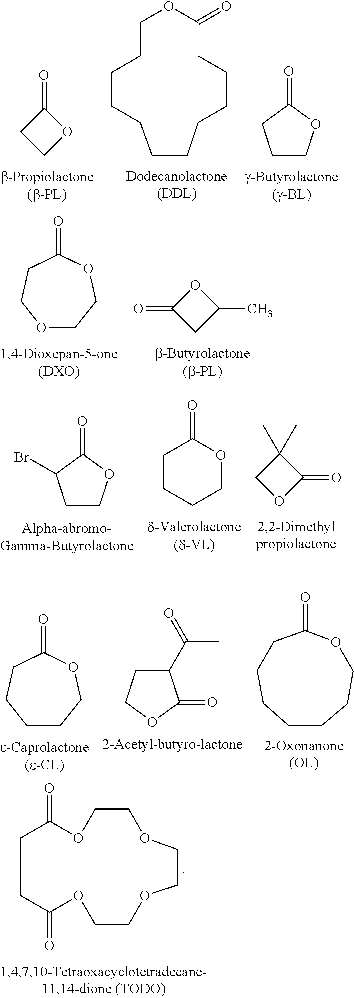

27. The self-doped polymer, or copolymer, composition according to claim 1, wherein the compound contains aromatic rings formed from repeating of polyaniline and wherein at least one aromatic ring in a repeating unit have at least one dopant groups thereon.

28. The self-doped polymer, or copolymer, composition according to claim 1, wherein the compound contains aromatic rings formed from repeating of polyaniline an wherein at least two aromatic rings in a repeating unit have at least one dopant groups thereon.

29.-31. (canceled)
